(19) United States
(12) Patent Application Publication
(10) Pub. No.: US 2024/0368022 A1
(43) Pub. Date: Nov. 7, 2024

(54) GLASS COMPOSITIONS AND GLASS LAMINATE ARTICLES COMPRISING THE SAME

(71) Applicant: CORNING INCORPORATED, CORNING, NY (US)

(72) Inventors: Venkatesh Botu, Corning, NY (US); Ling Cai, Painted Post, NY (US); Jesse Kohl, Horseheads, NY (US); Mark Owen Weller, Painted Post, NY (US)

(21) Appl. No.: 18/687,011

(22) PCT Filed: Aug. 16, 2022
(86) PCT No.: PCT/US22/40421

§ 371 Date: Feb. 27, 2024

Related U.S. Application Data
(60) Provisional application No. 63/238,814, filed on Aug. 31, 2021.

(51) Int. Cl. C03C 3/091; B32B 17/06; C03B 17/06; C03C 15/00

(52) U.S. Cl. CPC C03C 3/091; B32B 17/06; C03B 17/064; C03C 15/00

(57) ABSTRACT

A glass composition includes from 50 mol % to 80 mol % SiO₂; from 5 mol % to 15 mol % Al₂O₃; from 10 mol % to 25 mol % B₂O₃; greater than or equal to 0 mol % Li₂O; greater than or equal to 0 mol % Na₂O; greater than or equal to 0 mol % K₂O; greater than or equal to 0 mol % Rb₂O; greater than or equal to 0 mol % Cs₂O; from 1.5 mol % to 5 mol % MgO; from 4 mol % to 12 mol % CaO; and from 0.5 mol % to 5 mol % SrO. R₂O is from 0.1 mol % to 15 mol %, R₂O being the sum of Li₂O, Na₂O, K₂O, Rb₂O, and Cs₂O.

### CROSS-REFERENCE TO RELATED APPLICATIONS

This application claims the benefit of priority under 35 U.S.C. § 119 of U.S. Provisional Application No. 63/238,814 filed Aug. 31, 2021, the content of which is incorporated herein by reference in its entirety.

### FIELD

The present specification relates to glass compositions and glass laminate articles and, in particular, to glass compositions capable of phase separation to form anti-reflective (AR) glass laminate articles.

### TECHNICAL BACKGROUND

Reflection of light on non-AR coated glass surfaces occurs at the air-glass interface and may be up to 8% of light reflected at normal incidence, as predicted from the Fresnel equation. Conventional technologies to minimize reflection include AR coatings disposed on glass surfaces to reduce intensity of the reflected light. Anti-reflective coatings often comprise layers of multiple low- and high-index materials that destructively interfere different reflections within the stack thereby reducing reflection.

An alternative to AR coatings is anti-glare (AG) processing by etch patterning a surface of the glass, textured coatings, or the use of bulk scatters such that incoming light is scattered away from specular directions.

However, both conventional AR and AG techniques suffer from cost and time limitations (e.g., AR coatings often require multiple coatings of varying compositions) and may be difficult to control.

Accordingly, a need exists for alternative glasses with improved AR properties.

### SUMMARY

According to a first aspect A1, a glass composition may comprise: greater than or equal to 50 mol % and less than or equal to 80 mol % SiO₂; greater than or equal to 5 mol % and less than or equal to 15 mol % Al₂O₃; greater than or equal to 10 mol % and less than or equal to 25 mol % B₂O₃; greater than or equal to 0 mol % Li₂O; greater than or equal to 0 mol % Na₂O; greater than or equal to 0 mol % K₂O; greater than or equal to 0 mol % Rb₂O; greater than or equal to 0 mol % Cs₂O; greater than or equal to 1.5 mol % and less than or equal to 5 mol % MgO; greater than or equal to 4 mol % and less than or equal to 12 mol % CaO; and greater than or equal to 0.5 mol % and less than or equal to 5 mol % SrO, wherein: R₂O is greater than or equal to 0.1 mol % and less than or equal to 15 mol %, R₂O being the sum of Li₂O, Na₂O, K₂O, Rb₂O, and Cs₂O.

A second aspect A2 includes the glass composition according to the first aspect A1, wherein R₂O is greater than or equal to 0.25 mol % and less than or equal to 12 mol %.

A third aspect A3 includes the glass composition according to the second aspect A2, wherein R₂O is greater than or equal to 0.5 mol % and less than or equal to 10 mol %.

A fourth aspect A4 includes the glass composition according to any one of the first through third aspects A1-A3, wherein the glass composition comprises greater than or equal to 13 mol % and less than or equal to 25 mol % B₂O₃.

A fifth aspect A5 includes the glass composition according to the fourth aspect A4, wherein, the glass composition comprises greater than or equal to 14 mol % and less than or equal to 22 mol % B₂O₃.

A sixth aspect A6 includes the glass composition according to the fifth aspect A5, wherein the glass composition comprises greater than or equal to 15 mol % and less than or equal to 19 mol % B₂O₃.

A seventh aspect A7 includes the glass composition according to any one of the first through sixth aspects A1-A6, wherein the glass composition comprises greater than or equal to 6 mol % and less than or equal to 13 mol % Al₂O₃.

An eighth aspect A8 includes the glass composition according to the seventh aspect A7, wherein the glass composition comprises greater than or equal to 7 mol % and less than or equal to 11 mol % Al₂O₃.

A ninth aspect A9 includes the glass composition according any one of the first aspect through eighth aspects A1-A8, wherein the glass composition comprises greater than or equal to 1.75 mol % and less than or equal to 4 mol % MgO.

A tenth aspect A10 includes the glass composition according to the ninth aspect A9, wherein the glass composition comprises greater than or equal to 2 mol % and less than or equal to 3 mol % MgO.

An eleventh aspect A11 includes the glass composition according to any one of the first through tenth aspects A1-A10, wherein the glass composition comprises greater than or equal to 4.5 mol % and less than or equal to 10 mol % CaO.

A twelfth aspect A12 includes the glass composition according to the eleventh aspect A11, wherein the glass composition comprises greater than or equal to 5 mol % and less than or equal to 9 mol % CaO.

A thirteenth aspect A13 includes the glass composition according to any one of the first through twelfth aspects A1-A12, wherein the glass composition comprises greater than or equal to 0.75 mol % and less than or equal to 4 mol % SrO.

A fourteenth aspect A14 includes the glass composition according to the thirteenth aspect A13, wherein the glass composition comprises greater than or equal to 1 mol % and less than or equal to 3 mol % SrO.

A fifteenth aspect A15 includes the glass composition according to any one of the first through fourteenth aspects A1-A14, wherein the glass composition further comprises greater than 0 mol % and less than or equal to 5 mol % BaO.

A sixteenth aspect A16 includes the glass composition according to the fifteenth aspect A15, wherein the glass composition comprises greater than 0 mol % and less than or equal to 4 mol % BaO.

A seventeenth aspect A17 includes the glass composition according to the sixteenth aspect A16, wherein the glass composition comprises greater than 0 mol % and less than or equal to 3 mol % BaO.

An eighteenth aspect A18 includes the glass composition according to any one of the first through seventeenth aspects A1-A17, wherein the glass composition further comprises greater than 0 mol % and less than or equal 0.5 mol % SnO₂.

A nineteenth aspect A19 includes the glass composition according to the eighteenth aspect A18, wherein the glass composition comprises greater than or equal to 0.01 mol % and less than or equal 0.25 mol % SnO₂.

A twentieth aspect A20 includes the glass composition according to the nineteenth aspect A19, wherein the glass composition comprises greater than or equal to 0.05 mol % and less than or equal 0.1 mol % SnO₂.

A twenty-first aspect A21 includes the glass composition according to the twentieth aspect A20, wherein the glass composition comprises greater than or equal to 0.1 mol % and less than or equal 0.5 mol % SnO₂.

A twenty-second aspect A22 includes the glass composition according to any one of the first through twenty-first aspects A1-A21, wherein the glass composition comprises greater than or equal to 55 mol % and less than or equal to 75 mol % SiO₂.

A twenty-third aspect A23 includes the glass composition according to the twenty-second aspect A22, wherein the glass composition comprises greater than or equal to 60 mol % and less than or equal to 70 mol % SiO₂.

A twenty-fourth aspect A24 includes the glass composition according to any one of the first through twenty-third aspects A1-A23, wherein the glass composition is phase separable into a first phase and at least one second phase.

A twenty-fifth aspect A25 includes the glass composition according to any one of the first through twenty-fourth aspects A1-A24, wherein the glass composition has a liquidus viscosity greater than or equal to 10 kP and less than or equal to 15000 kP.

A twenty-sixth aspect A26 include the glass composition according to any one of the first through twenty-fifth aspects A1-A25, wherein the glass composition has a melt resistivity greater than or equal to 0.5 ohm-m and less than or equal to 15 ohm-m.

A twenty-seventh aspect A27 includes the glass composition according to any one of the first through twenty-sixth aspects A1-A26, wherein the glass composition has a shear modulus greater than or equal to 20 GPa and less than or equal to 35 GPa.

A twenty-eighth aspect A28 includes the glass composition according to any one of the first through twenty-seventh aspects A1-A27, wherein the glass composition has a Young's modulus greater than or equal to 60 GPa and less than or equal to 75 GPa.

A twenty-ninth aspect A29 includes the glass composition according to any of the first through twenty-eighth aspects A1-A28, wherein the glass composition has a Vickers hardness greater than or equal to 500 VHN and less than or equal 650 VHN.

According to a thirtieth aspect A30, a glass laminate article may comprise: a core glass layer; and a clad glass layer laminated to a surface of the core glass layer, wherein: the core glass layer is formed from the glass composition according to any one of the first through twenty-ninth aspects A1-A29.

According to a thirty-first aspect A31, a method for forming a glass laminate article may comprise: fusing at least one glass cladding layer to at least a portion of a glass core layer, wherein the at least one glass cladding layer comprises a phase separable glass composition and comprises: greater than or equal to 50 mol % and less than or equal to 80 mol % SiO₂; greater than or equal to 5 mol % and less than or equal to 15 mol % Al₂O₃; greater than or equal to 10 mol % and less than or equal to 25 mol % B₂O₃; greater than or equal to 0 mol % Li₂O; greater than or equal to 0 mol % Na₂O; greater than or equal to 0 mol % K₂O; greater than or equal to 0 mol % Rb₂O; greater than or equal to 0 mol % Cs₂O; greater than or equal to 1.5 mol % and less than or equal to 5 mol % MgO; greater than or equal to 4 mol % and less than or equal to 12 mol % CaO; and greater than or equal to 0.5 mol % and less than or equal to 5 mol % SrO, wherein: R₂O is greater than or equal to 0.1 mol % and less than or equal to 15 mol %, R₂O being the sum of Li₂O, Na₂O, K₂O, Rb₂O, and Cs₂O; heating the at least one glass cladding layer fused to the glass core layer to a temperature sufficient to effect a phase separation in the at least one glass cladding layer such that, after the heating, the at least one glass cladding layer comprises a first phase and at least one second phase, each of the first phase and the at least one second phase having different compositions; and etching the phase separated at least one glass cladding layer with an etching solution to selectively remove the at least one second glass phase from the at least one glass cladding layer such that the at least one glass cladding layer comprises a porous, interconnected matrix formed from the first phase of the phase separable glass composition.

A thirty-second aspect A32 includes the method according to the thirty-first aspect A31, wherein heating the at least one glass cladding layer comprises holding the at least one glass cladding layer at a temperature greater than or equal to 650° C. and less than or equal to 850° C. for a time period greater than or equal to 0.25 hour and less than or equal to 8 hours.

A thirty-third aspect A33 includes the method according to the thirty-first aspect A31 or thirty-second aspect A32, wherein the first phase comprises an interconnected matrix and the at least one second phase is dispersed throughout the interconnected matrix.

A thirty-fourth aspect A34 includes the method according to the thirty-third aspect A33, wherein the at least one second phase is interconnected within the interconnected matrix of the first phase.

A thirty-fifth aspect A35 includes the method according to any one of the thirty-first through thirty-fourth aspects A31-A34, wherein the etched at least one glass cladding layer has a refractive index greater than or equal to 1.15 and less than or equal to 1.3.

A thirty-sixth aspect A36 includes the method according to any one of the thirty-first through thirty-fifth aspects A31-A35, wherein the etched at least one glass cladding layer has an average pore size greater than or equal to 20 nm and less than or equal 60 nm.

A thirty-seventh aspect A37 includes the method according to any one of the thirty-first through thirty-sixth aspects A1-A36, wherein the etched at least one glass cladding layer has a porosity greater than or equal to 60% and less than or equal to 80%.

A thirty-eighth aspect A38 includes the method according to any one of the thirty-first through thirty-seventh aspects A1-A37, wherein the phase separated at least one glass cladding layer has an average transmittance greater than or equal to 85% and less than or equal to 99% of light over the wavelength range of 400 nm to 750 nm as measured at an article thickness of 0.7 mm.

A thirty-ninth aspect A39 includes the method according to any one of the thirty-first through thirty-eighth aspects A1-A38, wherein the at least one glass cladding layer has a haze greater than or equal to 10% and less than or equal to 120%.

Additional features and advantages of the glass compositions and the glass laminate articles formed therefrom described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a cross-sectional view of a glass laminate article according to one or more embodiments described herein;

FIG. 2 is a schematic view of an embodiment of a fusion draw process for making the glass laminate article of FIG. 1;

FIG. 3 is a plan view of an electronic device incorporating any of the glass laminate articles described herein;

FIG. 4 is a perspective view of the electronic device of FIG. 3;

FIG. 5 is a plot of temperature vs. melt resistivity (x-axis: temperature; y-axis: melt resistivity) of a comparative glass composition and example glass compositions according to one or more embodiments described herein;

FIG. 6A is an image of a comparative glass composition on a black background after heat treatment at a given temperature and time;

FIG. 6B is an image of a comparative glass composition on a black background after heat treatment at a given temperature and time;

FIG. 6C is an image of a comparative glass composition on a black background after heat treatment at a given temperature and time;

FIG. 7A is an image of an example glass composition on a black background after heat treatment at a given temperature and time, according to one or more embodiments described herein;

FIG. 7B is an image of an example glass composition on a black background after heat treatment at a given temperature and time, according to one or more embodiments described herein;

FIG. 7C is an image of an example glass composition on a black background after heat treatment at a given temperature and time, according to one or more embodiments described herein;

FIG. 7D is an image of an example glass composition on a black background after heat treatment at a given temperature and time, according to one or more embodiments described herein;

FIG. 7E is an image of an example glass composition on a black background after heat treatment at a given temperature and time, according to one or more embodiments described herein;

FIG. 7F is an image of an example glass composition on a black background after heat treatment at a given temperature and time, according to one or more embodiments described herein;

FIG. 7G is an image of an example glass composition on a black background after heat treatment at a given temperature and time, according to one or more embodiments described herein;

FIG. 8A is an image of an example glass composition under edge illumination after heat treatment at a given temperature and time, according to one or more embodiments described herein;

FIG. 8B is an image of an example glass composition under edge illumination after heat treatment at a given temperature and time, according to one or more embodiments described herein;

FIG. 8C is an image of an example glass composition under edge illumination after heat treatment at a given temperature and time, according to one or more embodiments described herein;

FIG. 8D is an image of an example glass composition under edge illumination after heat treatment at a given temperature and time, according to one or more embodiments described herein;

FIG. 8E is an image of an example glass composition under edge illumination after heat treatment at a given temperature and time, according to one or more embodiments described herein;

FIG. 8F is an image of an example glass composition under edge illumination after heat treatment at a given temperature and time, according to one or more embodiments described herein;

FIG. 8G is an image of an example glass composition under edge illumination after heat treatment at a given temperature and time, according to one or more embodiments described herein;

FIG. 9A is an image of an example glass composition on a black background after heat treatment at a given temperature and time, according to one or more embodiments described herein;

FIG. 9B is an image of an example glass composition on a black background after heat treatment at a given temperature and time, according to one or more embodiments described herein;

FIG. 9C is an image of an example glass composition on a black background after heat treatment at a given temperature and time, according to one or more embodiments described herein;

FIG. 9D is an image of an example glass composition under edge illumination after heat treatment at a given temperature and time, according to one or more embodiments described herein;

FIG. 9E is an image of an example glass composition on a black background after heat treatment at a given temperature and time, according to one or more embodiments described herein;

FIG. 9F is an image of an example glass composition on a black background after heat treatment at a given temperature and time, according to one or more embodiments described herein;

FIG. 9G is an image of an example glass composition on a black background after heat treatment at a given temperature and time, according to one or more embodiments described herein;

FIG. 10A is an image of an example glass composition under edge illumination after heat treatment at a given temperature and time, according to one or more embodiments described herein;

FIG. 10B is an image of an example glass composition under edge illumination after heat treatment at a given temperature and time, according to one or more embodiments described herein;

FIG. 10C is an image of an example glass composition under edge illumination after heat treatment at a given temperature and time, according to one or more embodiments described herein;

FIG. 10D is an image of an example glass composition under edge illumination after heat treatment at a given temperature and time, according to one or more embodiments described herein;

FIG. 10E is an image of an example glass composition under edge illumination after heat treatment at a given temperature and time, according to one or more embodiments described herein;

FIG. 10F is an image of an example glass composition under edge illumination after heat treatment at a given temperature and time, according to one or more embodiments described herein;

FIG. 10G is an image of an example glass composition under edge illumination after heat treatment at a given temperature and time, according to one or more embodiments described herein;

FIG. 11 is a plot of wavelength vs. transmittance (x-axis: wavelength; y-axis: transmittance) of a comparative glass composition and an example glass composition afterheat treatment at a given temperature and time, according to one more embodiments described herein; and

FIG. 12 is a plot of wavelength vs. transmittance (x-axis: wavelength; y-axis: transmittance) of a comparative glass composition and an example glass composition afterheat treatment at a given temperature and time.

### DETAILED DESCRIPTION

Reference will now be made in detail to various embodiments of glass compositions for forming AR glass laminate articles. The glass compositions enable faster phase separation at relatively lower temperatures and have relatively lower melt resistivities, thereby enabling more efficient production of the AR glass laminate articles. According to embodiments, a glass composition may include greater than or equal to 50 mol % and less than or equal to 80 mol % SiO₂; greater than or equal to 5 mol % and less than or equal to 15 mol % Al₂O₃; greater than or equal to 10 mol % and less than or equal to 25 mol % B₂O₃; greater than or equal to 0 mol % Li₂O; greater than or equal to 0 mol % Na₂O; greater than or equal to 0 mol % K₂O; greater than or equal to 0 mol % Rb₂O; greater than or equal to 0 mol % Cs₂O; greater than or equal to 1.5 mol % and less than or equal to 5 mol % MgO; greater than or equal to 4 mol % and less than or equal to 12 mol % CaO; and greater than or equal to 0.5 mol % and less than or equal to 5 mol % SrO. R₂O is greater than or equal to 0.1 mol % and less than or equal to 15 mol %, R₂O being the sum of Li₂O, Na₂O, K₂O, Rb₂O, and Cs₂O. Various embodiments of glass compositions and methods of forming AR glass laminate articles therefrom will be referred to herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” itwill be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.1 mol %.

The terms “0 mol %” and “free,” when used to describe the concentration and/or absence of a particular constituent component in a glass composition, means that the constituent component is not present in the glass composition.

In embodiments of the glass compositions described herein, the concentrations of constituent components (e.g., SiO₂, Al₂O₃, and the like) are specified in mole percent (mol %) on an oxide basis, unless otherwise specified.

Transmittance data is measured using an X-Rite Ci7860 Benchtop Spetrophotometer having an integrating sphere. The measurement is of the total, which includes both diffuse and specular transmittance.

The term “average transmittance,” as used herein, refers to the average of transmittance measurements made within a given wavelength range with each whole numbered wavelength weighted equally. In embodiments described herein, the “average transmittance” is reported over the wavelength range from 400 nm to 700 nm (inclusive of endpoints).

The term “transmission haze,” as used herein, refers to the ratio of transmitted light scattered at an angle greater than 2.5° from normal to all transmitted light over the total transmission. Transmission haze, as described herein, is measured in accordance with ASTM D1003 with a standard CIE-C illuminant with a wavelength range of 400 nm to 700 nm at a thickness of 2 mm, unless otherwise indicated.

The term “melting point,” as used herein, refers to the temperature at which the viscosity of the glass composition is 200 poise as measured in accordance with ASTM C338.

The term “softening point,” as used herein, refers to the temperature at which the viscosity of the glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The term “annealing point,” as used herein, refers to the temperature at which the viscosity of the glass composition is 1×10^{13.18} poise as measured in accordance with ASTM C598.

The term “strain point,” as used herein, refers to the temperature at which the viscosity of the glass composition is 1×10^{14.68} poise as measured in accordance with ASTM C598.

The term “liquidus viscosity,” as used herein, refers to the viscosity of the glass composition atthe onset of devitrification (i.e., atthe liquidus temperature as determined with the gradient furnace method according to ASTM C829-81).

The term “liquidus temperature,” as used herein, refers to the temperature at which the precursor glass composition begins to devitrify as determined with the gradient furnace method according to ASTM C829-81.

The elastic modulus (also referred to as Young's modulus) of the glass composition, as described herein, is provided in units of gigapascals (GPa) and is measured in accordance with ASTM C623.

The shear modulus of the glass-ceramic article, as described herein, is provided in units of gigapascals (GPa) and is measured in accordance with ASTM C623.

Vickers hardness, as described herein, is measured in accordance with a modified ASTM C1327. A load of 200 g was used. Additionally, a research grade reflected light microscope was used to do the measurement of diagonal length.

Poisson's ratio, as described herein is measured in accordance with ASTM C623.

The term “linear coefficient of thermal expansion” and “CTE,” as described herein, is measured in accordance with ASTM E228-85 as an average over the temperature range of 25° C. to 300° C. and is expressed in terms of “×10⁻⁷/° C.”

Density, as described herein, is measured by the buoyancy method of ASTM C693-93.

The term “phase separable glass composition,” as used herein, refers to a glass composition which undergoes phase separation into two or more distinct phases upon exposure to a phase separation treatment, such as a heat treatment or the like.

Refractive index, as described herein, is measured in accordance with ASTM E1967.

Melt resistivity, as described herein, is measured according to a platinum coaxial probe method at 1300° C. to 1550° C. as explained in “S. L. Schiefelbein, N. A. Fried, K. G. Rhoads, D. R. Sadoway: “A high-accuracy, calibration-free technique for measuring the electrical conductivity of liquids”; Review of Scientific Instruments, vol. 69, September 1998, no. 9, p 153-158.”

The term “porosity,” as described herein, refers to open porosity where the glass includes a network of interconnected pores and is measured using a scanning electron microscope (SEM). An image analysis is used to create a map of the open and closed pores, which allows for the calculation of the porosity.

The term “average pore size,” as described herein, refers to open porosity where the glass includes a network of interconnected pores and is measured using SEM. An image analysis is used to create a map of open pores within an area of the glass, which allows for the calculation of the average pore size.

Generally, a cladding layer in an AR glass laminate article may be achieved using a two-step process including phase separation and etching. However, conventional glass compositions used to form the cladding layer of a glass laminate may require higher processing temperatures, longer time periods, and/or greater energy for melting to achieve a finished product, thereby increasing the cost and time needed to form the AR glass laminate article.

Disclosed herein are glass compositions and glass laminate articles formed therefrom which mitigate the aforementioned problems. Specifically, the glass compositions described herein include concentrations of R₂O (i.e., Li₂O, Na₂O, K₂O, Rb₂O, and/or Cs₂O), which enables glass compositions that may be phase separated relatively quickly at relatively lower temperatures to produce AR glass laminate articles. Moreover, the concentration of R₂O also lowers the melt resistivity of the glass compositions such that the glass compositions are easier to melt.

The glass compositions described herein are used to forma glass cladding layer of a glass laminate and are susceptible to phase separation upon exposure to a phase separation treatment. In embodiments, the phase separated glass of the glass cladding layer may be a spinodally phase separated glass (i.e., the glass cladding layers are formed from a glass composition which is susceptible to spinodal decomposition). In these embodiments, the glass cladding layer includes an interconnected matrix of glass formed from the first phase with at least one second phase dispersed throughout the interconnected matrix of the first phase. The at least one second phase may be itself interconnected within the interconnected matrix of the first phase. In these embodiments, the first phase and the at least one second phase may have different dissolution rates in water, alkaline solutions, and/or acidic solutions. For example, the at least one second phase present in the phase separated glass cladding layer may more readily dissolve in water and/or acidic solutions than the first phase. Alternatively, the first phase present in the phase separated glass cladding layer may more readily dissolve in water and/or acidic solutions than the at least one second phase. This characteristic enables either the first phase or the at least one second phase to be selectively removed from the glass cladding layer such that the glass cladding layer is a porous, interconnected matrix formed from the remaining phase of the phase separated glass composition. The remaining phase of the phase separated glass composition may have the physical properties (e.g., refractive index, average pore size, porosity) necessary to achieve an AR glass laminate article.

These phase separable glass compositions may be described as modified aluminoborosilicate glass compositions (i.e., aluminoborosilicates containing alkali and alkaline earth elements) and comprise SiO₂, Al₂O₃, and B₂O₃. The glass compositions described herein include R₂O, R₂O being the sum of Li₂O, Na₂O, K₂O, Rb₂O, and Cs₂O, to promote phase separation and increase the liquidus viscosities of the glass compositions such that the glass compositions may be phase separated at relatively lower temperatures and for relatively short periods of time. R₂O also improves the melting behavior by lowering the melt resistivity of the glass compositions. The glass compositions described herein further include MgO, CaO, and SrO, which, like R₂O, lowers the temperature required for melting and assists in improving melting behavior.

SiO₂ is the primary glass former in the glass compositions described herein and may function to stabilize the glass network structure. The concentration SiO₂ in the glass composition should be sufficiently high (e.g., greater than or equal to 50 mol %) to provide basic glass forming capability. The amount of SiO₂ may be limited (e.g., to less than or equal to 80 mol %) to control the melting point of the glass composition, as the melting temperature of pure SiO₂ or high SiO₂ glasses is undesirably high. Thus, limiting the concentration of SiO₂ may aid in improving the meltability and the formability of the glass composition.

Accordingly, in embodiments, the glass composition may comprise greater than or equal to 50 mol % and less than or equal to 80 mol % SiO₂. In embodiments, the glass composition may comprise greater than or equal 55 mol % and less than or equal to 75 mol % SiO₂. In embodiments, the glass composition may comprise greater than or equal to 60 mol % and less than or equal to 70 mol % SiO₂. In embodiments, the concentration of SiO₂ in the glass composition may be greater than or equal to 50 mol %, greater than or equal to 55 mol %, or even greater than or equal to 60 mol %. In embodiments, the concentration of SiO₂ in the glass composition may be less than or equal to 80 mol %, less than or equal to 75 mol %, or even less than or equal to 70 mol %. In embodiments, the concentration of SiO₂ in the glass composition may be greater than or equal to 50 mol % and less than or equal to 80 mol %, greater than or equal to 50 mol % and less than or equal to 75 mol %, greater than or equal to 50 mol % and less than or equal to 70 mol %, greater than or equal to 55 mol % and less than or equal to 80 mol %, greater than or equal to 55 mol % and less than or equal to 75 mol %, greater than or equal to 55 mol % and less than or equal to 70 mol %, greater than or equal to 60 mol % and less than or equal to 80 mol %, greater than or equal to 60 mol % and less than or equal to 75 mol %, or even greater than or equal to 60 mol % and less than or equal to 70 mol %, or any and all sub-ranges formed from any of these endpoints.

Like SiO₂, Al₂O₃ may also stabilize the glass network and additionally provides improved mechanical properties and chemical durability to the glass composition. The amount of Al₂O₃ may also be tailored to control the viscosity of the glass composition. If the amount of Al₂O₃ is too high (e.g., greater than 15 mol %), the viscosity of the melt may increase, thereby diminishing the formability of the glass composition. In embodiments, the glass composition may comprise greater than or equal to 5 mol % and less than or equal to 15 mol % Al₂O₃. In embodiments, the glass composition may comprise greater than or equal to 6 mol % and less than or equal to 13 mol % Al₂O₃. In embodiments, the glass composition may comprise greater than or equal to 7 mol % and less than or equal to 11 mol % Al₂O₃. In embodiments, the concentration of Al₂O₃ in the glass composition may be greater than or equal to 5 mol %, greater than or equal to 6 mol %, or even greater than or equal to 7 mol %. In embodiments, the concentration of Al₂O₃ in the glass composition may be less than or equal to 15 mol %, less than or equal to 13 mol %, less than or equal to 11 mol %, or even less than or equal to 9 mol %. In embodiments, the concentration of Al₂O₃ in the glass composition may be greater than or equal to 5 mol % and less than or equal to 15 mol %, greater than or equal to 5 mol % and less than or equal to 13 mol %, greater than or equal to 5 mol % and less than or equal to 11 mol %, greater than or equal to 5 mol % and less than or equal to 9 mol %, greater than or equal to 6 mol % and less than or equal to 15 mol %, greater than or equal to 6 mol % and less than or equal to 13 mol %, greater than or equal to 6 mol % and less than or equal to 11 mol %, greater than or equal to 6 mol % and less than or equal to 9 mol %, greater than or equal to 7 mol % and less than or equal to 15 mol %, greater than or equal to 7 mol % and less than or equal to 13 mol %, greater than or equal to 7 mol % and less than or equal to 11 mol %, or even greater than or equal to 7 mol % and less than or equal to 9 mol %, or any and all sub-ranges formed from any of these endpoints.

Like SiO₂ and Al₂O₃, B₂O₃ contributes to the formation of the glass network. B₂O₃ decreases the melting temperature of the glass composition. In addition, the incorporation of B₂O₃ in the glass composition may also facilitate separating the glass composition into a silica-rich phase and a boric oxide-rich phase. In these embodiments, the silica-rich phase may be less susceptible to dissolution in water and/or an acidic solution than the boric oxide-rich phase, which, in turn, facilitates the selective removal of the boric oxide-rich phase and the formation of a porous microstructure in the glass laminate article. In embodiments, the glass composition may comprise greater than or equal to 10 mol % and less than or equal to 25 mol % B₂O₃. In embodiments, the glass composition may comprise greater than or equal to 13 mol % and less than or equal to 25 mol % B₂O₃. In embodiments, the glass composition may comprise greater than or equal to 14 mol % and less than or equal to 22 mol % B₂O₃. In embodiments, the glass composition may comprise greater than or equal to 15 mol % and less than or equal to 19 mol % B₂O₃. In embodiments, the concentration of B₂O₃ in the glass composition may be greater than or equal to 10 mol %, greater than or equal to 13 mol %, greater than or equal to 14 mol %, or even greater than or equal to 15 mol %. In embodiments, the concentration of B₂O₃ in the glass composition may be less than or equal to 25 mol %, less than or equal to 22 mol %, less than or equal to 19 mol %, or even less than or equal to 17 mol %. In embodiments, the concentration of B₂O₃ in the glass composition may be greater than or equal to 10 mol % and less than or equal to 25 mol %, greater than or equal to 10 mol % and less than or equal to 22 mol %, greater than or equal to 10 mol % and less than or equal to 19 mol %, greater than or equal to 10 mol % and less than or equal to 17 mol %, greater than or equal to 13 mol % and less than or equal to 25 mol %, greater than or equal to 13 mol % and less than or equal to 22 mol %, greater than or equal to 13 mol % and less than or equal to 19 mol %, greater than or equal to 13 mol % and less than or equal to 17 mol %, greater than or equal to 14 mol % and less than or equal to 25 mol %, greater than or equal to 14 mol % and less than or equal to 22 mol %, greater than or equal to 14 mol % and less than or equal to 19 mol %, greater than or equal to 14 mol % and less than or equal to 17 mol %, greater than or equal to 15 mol % and less than or equal to 25 mol %, greater than or equal to 15 mol % and less than or equal to 22 mol %, greater than or equal to 15 mol % and less than or equal to 19 mol %, or even greater than or equal to 15 mol % and less than or equal to 17 mol %, or any and all sub-ranges formed from any of these endpoints.

As used herein, R₂O is the sum (in mol %) of Li₂O, Na₂O, K₂O, Rb₂O, and Cs₂O (i.e., R₂O═Li₂O (mol %)+Na₂O (mol %)+K₂O (mol %)+Rb₂O (mol %)+Cs₂O (mol %)) present in the glass composition. As described herein, R₂O in the glass composition promotes phase separation and increases the liquidus viscosity of the glass composition such that the glass composition may be phase separated at lower temperatures for relatively shorter periods of time. In particular, R₂O aids in decreasing the softening point and molding temperature of the glass composition, thereby offsetting the increase in the softening point and molding temperature of the glass composition due to a higher amount of SiO₂ in the glass composition, for example. R₂O also improves the melting behavior by lowering the melt resistivity of the glass composition such that the glass compositions are easier to melt.

In embodiments, the concentration of R₂O in the glass composition may be greater than or equal to 0.1 mol % and less than or equal to 15 mol %. In embodiments, the concentration of R₂O in the glass composition may be greater than or equal to 0.25 mol % and less than or equal to 12 mol %. In embodiments, the concentration of R₂O in the glass composition may be greater than or equal to 0.5 mol % and less than or equal to 10 mol %. In embodiments, the concentration of R₂O in the glass composition may be greater than or equal to 0.1 mol %, greater than or equal to 0.25 mol %, greater than or equal to 0.5 mol %, greater than or equal to 0.75 mol %, or even greater than or equal to 1 mol %. In embodiments, the concentration of R₂O in the glass composition may be less than or equal to 15 mol %, less than or equal to 12 mol %, less than or equal to 10 mol %, less than or equal to 8 mol %, less than or equal to 5 mol %, or even less than or equal to 2 mol %. In embodiments, the concentration of R₂O in the glass composition may be greater than or equal to 0.1 mol % and less than or equal to 15 mol %, greater than or equal to 0.1 mol % and less than or equal to 12 mol %, greater than or equal to 0.1 mol % and less than or equal to 10 mol %, greater than or equal to 0.1 mol % and less than or equal to 8 mol %, greater than or equal to 0.1 mol % and less than or equal to 5 mol %, greater than or equal to 0.1 mol % and less than or equal to 2 mol %, greater than or equal to 0.25 mol % and less than or equal to 15 mol %, greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 0.25 mol % and less than or equal to 5 mol %, greater than or equal to 0.25 mol % and less than or equal to 2 mol %, greater than or equal to 0.5 mol % and less than or equal to 15 mol %, greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 5 mol %, greater than or equal to 0.5 mol % and less than or equal to 2 mol %, greater than or equal to 0.75 mol % and less than or equal to 15 mol %, greater than or equal to 0.75 mol % and less than or equal to 12 mol %, greater than or equal to 0.75 mol % and less than or equal to 10 mol %, greater than or equal to 0.75 mol % and less than or equal to 8 mol %, greater than or equal to 0.75 mol % and less than or equal to 5 mol %, greater than or equal to 0.75 mol % and less than or equal to 2 mol %, greater than or equal to 1 mol % and less than or equal to 15 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 5 mol %, or even greater than or equal to 1 mol % and less than or equal to 2 mol %, or any and all sub-ranges formed from any of these endpoints.

In embodiments, the glass composition may comprise greater than or equal to 0 mol % Li₂O. In embodiments, the concentration of Li₂O in the glass composition may be greater than or eq greater than or equal to 0 mol %, greater than or equal to 0.25 mol %, greater than or equal to 0.5 mol %, greater than or equal to 0.75 mol %, or even greater than or equal to 1 mol %. In embodiments, the concentration of Li₂O in the glass composition may be less than or equal to 15 mol %, less than or equal to 12 mol %, less than or equal to 10 mol %, less than or equal to 8 mol %, less than or equal to 5 mol %, or even less than or equal to 2 mol %. In embodiments, the concentration of Li₂O in the glass composition may be greater than or equal to 0 mol % and less than or equal to 15 mol %, greater than or equal to 0 mol % and less than or equal to 12 mol %, greater than or equal to 0 mol % and less than or equal to 10 mol %, greater than or equal to 0 mol % and less than or equal to 8 mol %, greater than or equal to 0 mol % and less than or equal to 5 mol %, greater than or equal to 0 mol % and less than or equal to 2 mol %, greater than or equal to 0.25 mol % and less than or equal to 15 mol %, greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 0.25 mol % and less than or equal to 5 mol %, greater than or equal to 0.25 mol % and less than or equal to 2 mol %, greater than or equal to 0.5 mol % and less than or equal to 15 mol %, greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 5 mol %, greater than or equal to 0.5 mol % and less than or equal to 2 mol %, greater than or equal to 0.75 mol % and less than or equal to 15 mol %, greater than or equal to 0.75 mol % and less than or equal to 12 mol %, greater than or equal to 0.75 mol % and less than or equal to 10 mol %, greater than or equal to 0.75 mol % and less than or equal to 8 mol %, greater than or equal to 0.75 mol % and less than or equal to 5 mol %, greater than or equal to 0.75 mol % and less than or equal to 2 mol %, greater than or equal to 1 mol % and less than or equal to 15 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 5 mol %, or even greater than or equal to 1 mol % and less than or equal to 2 mol %, or any and all sub-ranges formed from any of these endpoints. In embodiments, the glass composition may be free or substantially free of Li₂O.

In embodiments, the glass composition may comprise greater than or equal to 0 mol % Na₂O. In embodiments, the concentration of Na₂O in the glass composition may be greater than or eq greater than or equal to 0 mol %, greater than or equal to 0.25 mol %, greater than or equal to 0.5 mol %, greater than or equal to 0.75 mol %, or even greater than or equal to 1 mol %. In embodiments, the concentration of Na₂O in the glass composition may be less than or equal to 15 mol %, less than or equal to 12 mol %, less than or equal to 10 mol %, less than or equal to 8 mol %, less than or equal to 5 mol %, or even less than or equal to 2 mol %. In embodiments, the concentration of Na₂O in the glass composition may be greater than or equal to 0 mol % and less than or equal to 15 mol %, greater than or equal to 0 mol % and less than or equal to 12 mol %, greater than or equal to 0 mol % and less than or equal to 10 mol %, greater than or equal to 0 mol % and less than or equal to 8 mol %, greater than or equal to 0 mol % and less than or equal to 5 mol %, greater than or equal to 0 mol % and less than or equal to 2 mol %, greater than or equal to 0.25 mol % and less than or equal to 15 mol %, greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 0.25 mol % and less than or equal to 5 mol %, greater than or equal to 0.25 mol % and less than or equal to 2 mol %, greater than or equal to 0.5 mol % and less than or equal to 15 mol %, greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 5 mol %, greater than or equal to 0.5 mol % and less than or equal to 2 mol %, greater than or equal to 0.75 mol % and less than or equal to 15 mol %, greater than or equal to 0.75 mol % and less than or equal to 12 mol %, greater than or equal to 0.75 mol % and less than or equal to 10 mol %, greater than or equal to 0.75 mol % and less than or equal to 8 mol %, greater than or equal to 0.75 mol % and less than or equal to 5 mol %, greater than or equal to 0.75 mol % and less than or equal to 2 mol %, greater than or equal to 1 mol % and less than or equal to 15 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 5 mol %, or even greater than or equal to 1 mol % and less than or equal to 2 mol %, or any and all sub-ranges formed from any of these endpoints. In embodiments, the glass composition may be free or substantially free of Na₂O.

In embodiments, the glass composition may comprise greater than or equal to 0 mol % K₂O. In embodiments, the concentration of K₂O in the glass composition may be greater than or equal to 0 mol %, greater than or equal to 0.25 mol %, greater than or equal to 0.5 mol %, greater than or equal to 0.75 mol %, or even greater than or equal to 1 mol %. In embodiments, the concentration of K₂O in the glass composition may be less than or equal to 15 mol %, less than or equal to 12 mol %, less than or equal to 10 mol %, less than or equal to 8 mol %, less than or equal to 5 mol %, or even less than or equal to 2 mol %. In embodiments, the concentration of K₂O in the glass composition may be greater than or equal to 0 mol % and less than or equal to 15 mol %, greater than or equal to 0 mol % and less than or equal to 12 mol %, greater than or equal to 0 mol % and less than or equal to 10 mol %, greater than or equal to 0 mol % and less than or equal to 8 mol %, greater than or equal to 0 mol % and less than or equal to 5 mol %, greater than or equal to 0 mol % and less than or equal to 2 mol %, greater than or equal to 0.25 mol % and less than or equal to 15 mol %, greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 0.25 mol % and less than or equal to 5 mol %, greater than or equal to 0.25 mol % and less than or equal to 2 mol %, greater than or equal to 0.5 mol % and less than or equal to 15 mol %, greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 5 mol %, greater than or equal to 0.5 mol % and less than or equal to 2 mol %, greater than or equal to 0.75 mol % and less than or equal to 15 mol %, greater than or equal to 0.75 mol % and less than or equal to 12 mol %, greater than or equal to 0.75 mol % and less than or equal to 10 mol %, greater than or equal to 0.75 mol % and less than or equal to 8 mol %, greater than or equal to 0.75 mol % and less than or equal to 5 mol %, greater than or equal to 0.75 mol % and less than or equal to 2 mol %, greater than or equal to 1 mol % and less than or equal to 15 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 5 mol %, or even greater than or equal to 1 mol % and less than or equal to 2 mol %, or any and all sub-ranges formed from any of these endpoints. In embodiments, the glass composition may be free or substantially free of K₂O.

In embodiments, the glass composition may comprise greater than or equal to 0 mol % Rb₂O. In embodiments, the concentration of Rb₂O in the glass composition may be greater than or equal to 0 mol %, greater than or equal to 0.25 mol %, greater than or equal to 0.5 mol %, greater than or equal to 0.75 mol %, or even greater than or equal to 1 mol %. In embodiments, the concentration of Rb₂O in the glass composition may be less than or equal to 15 mol %, less than or equal to 12 mol %, less than or equal to 10 mol %, less than or equal to 8 mol %, less than or equal to 5 mol %, or even less than or equal to 2 mol %. In embodiments, the concentration of Rb₂O in the glass composition may be greater than or equal to 0 mol % and less than or equal to 15 mol %, greater than or equal to 0 mol % and less than or equal to 12 mol %, greater than or equal to 0 mol % and less than or equal to 10 mol %, greater than or equal to 0 mol % and less than or equal to 8 mol %, greater than or equal to 0 mol % and less than or equal to 5 mol %, greater than or equal to 0 mol % and less than or equal to 2 mol %, greater than or equal to 0.25 mol % and less than or equal to 15 mol %, greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 0.25 mol % and less than or equal to 5 mol %, greater than or equal to 0.25 mol % and less than or equal to 2 mol %, greater than or equal to 0.5 mol % and less than or equal to 15 mol %, greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 5 mol %, greater than or equal to 0.5 mol % and less than or equal to 2 mol %, greater than or equal to 0.75 mol % and less than or equal to 15 mol %, greater than or equal to 0.75 mol % and less than or equal to 12 mol %, greater than or equal to 0.75 mol % and less than or equal to 10 mol %, greater than or equal to 0.75 mol % and less than or equal to 8 mol %, greater than or equal to 0.75 mol % and less than or equal to 5 mol %, greater than or equal to 0.75 mol % and less than or equal to 2 mol %, greater than or equal to 1 mol % and less than or equal to 15 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 5 mol %, or even greater than or equal to 1 mol % and less than or equal to 2 mol %, or any and all sub-ranges formed from any of these endpoints. In embodiments, the glass composition may be free or substantially free of Rb₂O.

In embodiments, the glass composition may comprise greater than or equal to 0 mol % Cs₂O. In embodiments, the concentration of Cs₂O in the glass composition may be greater than or equal to 0 mol %, greater than or equal to 0.25 mol %, greater than or equal to 0.5 mol %, greater than or equal to 0.75 mol %, or even greater than or equal to 1 mol %. In embodiments, the concentration of Cs₂O in the glass composition may be less than or equal to 15 mol %, less than or equal to 12 mol %, less than or equal to 10 mol %, less than or equal to 8 mol %, less than or equal to 5 mol %, or even less than or equal to 2 mol %. In embodiments, the concentration of Cs₂O in the glass composition may be greater than or equal to 0 mol % and less than or equal to 15 mol %, greater than or equal to 0 mol % and less than or equal to 12 mol %, greater than or equal to 0 mol % and less than or equal to 10 mol %, greater than or equal to 0 mol % and less than or equal to 8 mol %, greater than or equal to 0 mol % and less than or equal to 5 mol %, greater than or equal to 0 mol % and less than or equal to 2 mol %, greater than or equal to 0.25 mol % and less than or equal to 15 mol %, greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 0.25 mol % and less than or equal to 5 mol %, greater than or equal to 0.25 mol % and less than or equal to 2 mol %, greater than or equal to 0.5 mol % and less than or equal to 15 mol %, greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 5 mol %, greater than or equal to 0.5 mol % and less than or equal to 2 mol %, greater than or equal to 0.75 mol % and less than or equal to 15 mol %, greater than or equal to 0.75 mol % and less than or equal to 12 mol %, greater than or equal to 0.75 mol % and less than or equal to 10 mol %, greater than or equal to 0.75 mol % and less than or equal to 8 mol %, greater than or equal to 0.75 mol % and less than or equal to 5 mol %, greater than or equal to 0.75 mol % and less than or equal to 2 mol %, greater than or equal to 1 mol % and less than or equal to 15 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 5 mol %, or even greater than or equal to 1 mol % and less than or equal to 2 mol %, or any and all sub-ranges formed from any of these endpoints. In embodiments, the glass composition may be free or substantially free of Cs₂O.

The glass compositions described herein further include MgO, CaO, and SrO. These alkaline earth oxides generally improve the melting behavior of the glass composition by lowering the temperature required for melting. Moreover, a combination of several different alkaline earth oxides may assist in lowering the liquidus temperature of the glass composition and increasing the liquidus viscosity of the glass composition.

In embodiments, the glass composition may comprise greater than or equal to 1.5 mol % and less than or equal to 5 mol % MgO. In embodiments, the glass composition may comprise greater than or equal to 1.75 mol % and less than or equal to 4 mol % MgO. In embodiments, the glass composition may comprise greater than or equal to 2 mol % and less than or equal to 3 mol % MgO. In embodiments, the concentration of MgO in the glass composition may be greater than or equal to 1.5 mol %, greater than or equal to 1.75 mol %, or even greater than or equal to 2 mol %. In embodiments, the concentration of MgO in the glass composition may be less than or equal to 5 mol %, less than or equal to 4 mol %, or even less than or equal to 3 mol %. In embodiments, the concentration of MgO in the glass composition may be greater than or equal to 1.5 mol % and less than or equal to 5 mol %, greater than or equal to 1.5 mol % and less than or equal to 4 mol %, greater than or equal to 1.5 mol % and less than or equal to 3 mol %, greater than or equal to 1.75 mol % and less than or equal to 5 mol %, greater than or equal to 1.75 mol % and less than or equal to 4 mol %, greater than or equal to 1.75 mol % and less than or equal to 3 mol %, greater than or equal to 2 mol % and less than or equal to 5 mol %, greater than or equal to 2 mol % and less than or equal to 4 mol %, or even greater than or equal to 2 mol % and less than or equal to 3 mol %, or any and all sub-ranges formed from any of these endpoints.

In embodiments, the glass composition may comprise greater than or equal to 4 mol % and less than or equal to 12 mol % CaO. In embodiments, the glass composition may comprise greater than or equal to 4.5 mol % and less than or equal to 10 mol % CaO. In embodiments, the glass composition may comprise greater than or equal to 5 mol % and less than or equal to 9 mol % CaO. In embodiments, the concentration of CaO in the glass composition may be greater than or equal to 4 mol %, greater than or equal to 4.5 mol %, greater than or equal to 5 mol %, greater than or equal to 5.5 mol %, or even greater than or equal to 6 mol %. In embodiments, the concentration of CaO in the glass composition may be less than or equal to 12 mol %, less than or equal to 10 mol %, less than or equal to 9 mol %, or even less than or equal to 8 mol %. In embodiments, the concentration of CaO in the glass composition may be greater than or equal to 4 mol % and less than or equal to 12 mol %, greater than or equal to 4 mol % and less than or equal to 10 mol %, greater than or equal to 4 mol % and less than or equal to 9 mol %, greater than or equal to 4 mol % and less than or equal to 8 mol %, greater than or equal to 4.5 mol % and less than or equal to 12 mol %, greater than or equal to 4.5 mol % and less than or equal to 10 mol %, greater than or equal to 4.5 mol % and less than or equal to 9 mol %, greater than or equal to 4.5 mol % and less than or equal to 8 mol %, greater than or equal to 5 mol % and less than or equal to 12 mol %, greater than or equal to 5 mol % and less than or equal to 10 mol %, greater than or equal to 5 mol % and less than or equal to 9 mol %, greater than or equal to 5 mol % and less than or equal to 8 mol %, greater than or equal to 5.5 mol % and less than or equal to 12 mol %, greater than or equal to 5.5 mol % and less than or equal to 10 mol %, greater than or equal to 5.5 mol % and less than or equal to 9 mol %, greater than or equal to 5.5 mol % and less than or equal to 8 mol %, greater than or equal to 6 mol % and less than or equal to 12 mol %, greater than or equal to 6 mol % and less than or equal to 10 mol %, greater than or equal to 6 mol % and less than or equal to 9 mol %, or even greater than or equal to 6 mol % and less than or equal to 8 mol %, or any and all sub-ranges formed from any of these endpoints.

In embodiments, the glass composition may comprise greater than or equal to 0.5 mol % and less than or equal to 5 mol % SrO. In embodiments, the glass composition may comprise greater than or equal to 0.75 mol % and less than or equal to 4 mol % SrO. In embodiments, the glass composition may comprise greater than or equal to 1 mol % and less than or equal to 3 mol % SrO. In embodiments, the concentration of SrO in the glass composition may be greater than or equal to 0.5 mol %, greater than or equal to 0.75 mol %, or even greater than or equal to 1 mol %. In embodiments, the concentration of SrO in the glass composition may be greater than or equal to 0.5 mol %, greater than or equal to 0.75 mol %, or even greater than or equal to 1 mol %. In embodiments, the concentration of SrO in the glass composition may be less than or equal to 5 mol %, less than or equal to 4 mol %, less than or equal to 3 mol %, or even less than or equal to 2 mol %. In embodiments, the concentration of SrO in the glass composition may be greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 0.75 mol % and less than or equal to 5 mol %, greater than or equal to 0.75 mol % and less than or equal to 4 mol %, greater than or equal to 0.75 mol % and less than or equal to 3 mol %, greater than or equal to 0.75 mol % and less than or equal to 2 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints.

In embodiments, the glass composition may further comprise BaO. In embodiments, the glass composition may comprise greater than 0 mol % and less than or equal to 5 mol % BaO. In embodiments, the glass composition may comprise greater than 0 mol % and less than or equal to 4 mol % BaO. In embodiments, the glass composition may comprise greater than 0 mol % and less than or equal to 3 mol % BaO. In embodiments, the concentration of BaO in the glass composition may be greater than 0 mol %, greater than or equal to 0.5 mol %, or even greater than or equal to 1 mol %. In embodiments, the concentration of BaO in the glass composition may be less than or equal to 5 mol %, less than or equal to 4 mol %, less than or equal to 3 mol %, or even less than or equal to 2 mol %. In embodiments, the concentration of BaO in the glass composition may be greater than 0 mol % and less than or equal to 5 mol %, greater than 0 mol % and less than or equal to 4 mol %, greater than 0 mol % and less than or equal to 3 mol %, greater than 0 mol % and less than or equal to 2 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the glass composition may be free or substantially free of BaO.

In embodiments, the glass compositions described herein may further include one or more fining agents. In embodiments, the fining agents may include, for example, SnO₂. In embodiments, the glass composition may comprise greater than 0 mol % and less than or equal 0.5 mol % SnO₂. In embodiments, the glass composition may comprise greater than or equal to 0.01 mol % and less than or equal 0.25 mol % SnO₂. In embodiments, the glass composition may comprise greater than or equal to 0.05 mol % and less than or equal 0.1 mol % SnO₂. In embodiments, the glass composition may comprise greater than or equal to 0.1 mol % and less than or equal 0.5 mol % SnO₂. In embodiments, the concentration of SnO₂ in the glass composition may be greater than 0 mol %, greater than or equal to 0.01 mol %, greater than or equal to 0.05 mol %, or even greater than or equal to 0.1 mol %. In embodiments, the concentration of SnO₂ in the glass composition may be less than or equal to 0.5 mol %, less than or equal to 0.25 mol %, or even less than or equal to 0.1 mol %. In embodiments, the concentration of SnO₂ in glass composition may be greater than 0 mol % and less than or equal 0.5 mol %, greater than 0 mol % and less than or equal 0.25 mol %, greater than 0 mol % and less than or equal 0.1 mol %, greater than or equal to 0.01 mol % and less than or equal to 0.5 mol %, greater than or equal to 0.01 mol % and less than or equal to 0.25 mol %, greater than or equal to 0.01 mol % and less than or equal to 0.1 mol %, greater than or equal to 0.05 mol % and less than or equal to 0.5 mol %, greater than or equal to 0.05 mol % and less than or equal to 0.25 mol %, greater than or equal to 0.05 mol % and less than or equal to 0.1 mol %, greater than or equal to 0.1 mol % and less than or equal to 0.5 mol %, or even greater than or equal to 0.1 mol % and less than or equal to 0.25 mol %, or any and all sub-ranges formed from any of these endpoints. In embodiments, the glass composition may be free or substantially free of SnO₂.

In embodiments, the glass compositions described herein may further include tramp materials such as TiO₂, MnO, MoO₃, WO₃, Y₂O₃, CdO, As₂O₃, Sb₂O₃, sulfur-based compounds, such as sulfates, halogens, or combinations thereof. In embodiments, the glass compositions and may be free or substantially free of individual tramp materials, a combination of tramp materials, or all tramp materials. For example, in embodiments, the glass compositions may be free or substantially free of TiO₂, MnO, MoO₃, WO₃, Y₂O₃, CdO, As₂O₃, Sb₂O₃, sulfur-based compounds, such as sulfates, halogens, or combinations thereof.

In embodiments, the glass compositions described herein used for forming a glass cladding layer have a liquidus viscosity which renders them suitable for use in a fusion draw process and, in particular, for use as a glass cladding composition for a fusion lamination process. For example, in embodiments, the glass composition may have a liquidus viscosity greater than or equal to 10 kP, greater than or equal to 50 kP, greater than or equal to 100 kP, greater than or equal to 250 kP, or even greater than or equal to 500 kP. In embodiments, the glass composition may have a liquidus viscosity less than or equal to 15000 kP, less than or equal to 5000 kP, less than or equal to 2500 kP, or even less than or equal to 1000 kP. In embodiments, the glass composition may have a liquidus viscosity greater than or equal to 10 kP and less than or equal to 15000 kP, greater than or equal to 10 kP and less than or equal to 5000 kP, greater than or equal to 10 kP and less than or equal to 2500 kP, greater than or equal to 10 kP and less than or equal to 1000 kP, greater than or equal to 50 kP and less than or equal to 15000 kP, greater than or equal to 50 kP and less than or equal to 5000 kP, greater than or equal to 50 kP and less than or equal to 2500 kP, greater than or equal to 50 kP and less than or equal to 1000 kP, greater than or equal to 100 kP and less than or equal to 15000 kP, greater than or equal to 100 kP and less than or equal to 5000 kP, greater than or equal to 100 kP and less than or equal to 2500 kP, greater than or equal to 100 kP and less than or equal to 1000 kP, greater than or equal to 250 kP and less than or equal to 15000 kP, greater than or equal to 250 kP and less than or equal to 5000 kP, greater than or equal to 250 kP and less than or equal to 2500 kP, greater than or equal to 250 kP and less than or equal to 1000 kP, greater than or equal to 500 kP and less than or equal to 15000 kP, greater than or equal to 500 kP and less than or equal to 5000 kP, greater than or equal to 500 kP and less than or equal to 2500 kP, or even greater than or equal to 500 kP and less than or equal to 1000 kP, or any and all sub-ranges formed from any of these endpoints.

In embodiments, the glass composition may have a liquidus temperature greater than or equal to 850° C. or even greater than or equal to 900° C. In embodiments, the glass composition may have a liquidus temperature less than or equal to 1050° C. or even less than or equal to 1000° C. In embodiments, the glass composition may have a liquidus temperature greater than or equal to 850° C. and less than or equal to 1050° C., greater than or equal to 850° C. and less than or equal to 1000° C., greater than or equal to 900° C. and less than or equal to 1050° C., or even greater than or equal to 900° C. and less than or equal to 1000° C., or any and all sub-ranges formed from any of these endpoints.

In embodiments, the glass composition may have a strain point greater than or equal 800° C. or even greater than or equal to 850° C. In embodiments, the glass composition may has a strain point less than or equal to 1000° C. or even less than or equal to 950° C. In embodiments, the glass composition may have a strain point greater than or equal 800° C. and less than or equal to 1000° C., greater than or equal 800° C. and less than or equal to 950° C., greater than or equal 850° C. and less than or equal to 1000° C., or even greater than or equal 850° C. and less than or equal to 950° C., or any and all sub-ranges formed from any of these endpoints.

In embodiments, the glass composition may have an annealing point greater than or equal to 550° C. or even greater than or equal to 600° C. In embodiments, the glass composition may have an annealing pointless than or equal to 750° C. or even less than or equal to 700° C. In embodiments, the glass composition may have an annealing point greater than or equal to 550° C. and less than or equal to 750° C., greater than or equal to 550° C. and less than or equal to 700° C., greater than or equal to 600° C. and less than or equal to 750° C., or even greater than or equal to 600° C. and less than or equal to 700° C., or any and all sub-ranges formed from any of these endpoints.

In embodiments, the glass composition may have a softening point greater than or equal to 500° C. or even greater than or equal to 550° C. In embodiments, the glass composition may have a softening pointless than or equal to 700° C. or even less than or equal to 650° C. In embodiments, the glass composition may have a softening point greater than or equal to 500° C. and less than or equal to 700° C., greater than or equal to 500° C. and less than or equal to 650° C., greater than or equal to 550° C. and less than or equal to 700° C., or even greater than or equal to 550° C. and less than or equal to 650° C., or any and all sub-ranges formed from any of these endpoints.

As described herein, the glass composition includes R₂O, which improves the melting behavior. In particular, alkali ion mobilities are higher than alkaline earth and network oxides such as Al₂O₃, B₂O₃, and SiO₂, and lower the melt resistivity of the glass compositions. In embodiments, the glass composition may have a melt resistivity greater than or equal to 0.5 ohm-m and less than or equal to 15 ohm-m. In embodiments, the glass composition may have a melt resistivity greater than or equal to 0.5 ohm-m, greater than or equal to 1 ohm-m, greater than or equal to 2 ohm-m, or even greater than or equal to 3 ohm-m. In embodiments, the glass composition may have a melt resistivity less than or equal to 15 ohm-m, less than or equal to 12.5 ohm-m, less than or equal to 10 ohm-m, or even less than or equal to 7.5 ohm-m. In embodiments, the glass composition may have a melt resistivity greater than or equal to 0.5 ohm-m and less than or equal to 15 ohm-m, greater than or equal to 0.5 ohm-m and less than or equal to 12.5 ohm-m, greater than or equal to 0.5 ohm-m and less than or equal to 10 ohm-m, greater than or equal to 0.5 ohm-m and less than or equal to 7.5 ohm-m, greater than or equal to 1 ohm-m and less than or equal to 15 ohm-m, greater than or equal to 1 ohm-m and less than or equal to 12.5 ohm-m, greater than or equal to 1 ohm-m and less than or equal to 10 ohm-m, greater than or equal to 1 ohm-m and less than or equal to 7.5 ohm-m, greater than or equal to 2 ohm-m and less than or equal to 15 ohm-m, greater than or equal to 2 ohm-m and less than or equal to 12.5 ohm-m, greater than or equal to 2 ohm-m and less than or equal to 10 ohm-m, greater than or equal to 2 ohm-m and less than or equal to 7.5 ohm-m, greater than or equal to 3 ohm-m and less than or equal to 15 ohm-m, greater than or equal to 3 ohm-m and less than or equal to 12.5 ohm-m, greater than or equal to 3 ohm-m and less than or equal to 10 ohm-m, or even greater than or equal to 3 ohm-m and less than or equal to 7.5 ohm-m, or any and all sub-ranges formed from any of these endpoints.

The glass compositions described herein may have improved mechanical properties (e.g. shear modulus, Young's modulus, Vickers hardness). While not wishing to be bound by theory, due to the presence of R₂O, the glass forming process may cause phase separation to occur in a portion of the glass prior to phase separation heat treatment. This phase separation may lead to improved mechanical properties. In embodiments, the glass composition may have a shear modulus greater than or equal to 20 GPa and less than or equal to 35 GPa. In embodiments, the glass composition may have a shear modulus greater than or equal to 20 GPa or even greater than or equal to 25 GPa. In embodiments, the glass composition may have a shear modulus less than or equal to 35 GPa or even less than or equal to 30 GPa. In embodiments, the glass composition may have a shear modulus greater than or equal to 20 GPa and less than or equal to 35 GPa, greater than or equal to 20 GPa and less than or equal to 30 GPa, greater than or equal to 25 GPa and less than or equal to 35 GPa, or even greater than or equal to 25 GPa and less than or equal to 30 GPa, or any and all sub-ranges formed from any of these endpoints.

In embodiments, the glass composition may have a Young's modulus greater than or equal to 60 GPa and less than or equal to 75 GPa. In embodiments, the glass composition may have a Young's modulus greater than or equal to 60 GPa or even greater than or 65 GPa. In embodiments, the glass composition may have a Young's modulus less than or equal to 75 GPa or even less than or equal to 70 GPa. In embodiments, the glass composition may have a Young's modulus greater than or equal to 60 GPa and less than or equal to 75 GPa, greater than or equal to 60 GPa and less than or equal to 70 GPa, greater than or equal to 65 GPa and less than or equal to 75 GPa, or even greater than or equal to 65 GPa and less than or equal to 70 GPa, or any and all sub-ranges formed from any of these endpoints.

In embodiments, the glass composition may have a Vickers hardness greater than or equal to 500 VHN and less than or equal 650 VHN. In embodiments, the glass composition 104a, 104b may have a Vickers hardness greater than or equal to 500 VHN or even greater than or equal to 550 VHN. In embodiments, the glass composition may have a Vickers hardness less than or equal to 650 VHN or even less than or equal to 600 VHN. In embodiments, the glass composition may have a Vickers hardness greater than or equal to 500 VHN and less than or equal 650 VHN, greater than or equal to 500 VHN and less than or equal 600 VHN, greater than or equal to 550 VHN and less than or equal 650 VHN, or even greater than or equal to 550 VHN and less than or equal 600 VHN, or any and all sub-ranges formed from any of these endpoints.

In embodiments, the glass composition may have a Poisson's ratio greater than or equal to 0.15 or even greater than or equal to 0.2. In embodiments, the glass composition may have a Poisson's ratio less than or equal to 0.3 or even less than or equal to 0.25. In embodiments, the glass composition may have a Poisson's ratio greater than or equal to 0.15 and less than or equal to 0.3, greater than or equal to 0.15 and less than or equal to 0.25, greater than or equal to 0.2 and less than or equal to 0.3, or even greater than or equal to 0.2 and less than or equal to 0.25, or any and all sub-ranges formed from any of these endpoints.

In embodiments, the glass composition may have a CTE greater than or equal to 25×10⁻⁷/° C. or even greater than or equal to 30×10⁻⁷/° C. In embodiments, the glass composition may have a CTE less than or equal to 45×10⁻⁷/° C. or even less than or equal to 40×10⁻⁷/° C. In embodiments, the glass composition may have a CTE greater than or equal to 25×10⁻⁷/° C. and less than or equal to 45×10⁻⁷/° C., greater than or equal to 25×10⁻⁷/° C. and less than or equal to 40×10⁻⁷/° C., greater than or equal to 30×10⁻⁷/° C. and less than or equal to 45×10-7/° C., or even greater than or equal to 30×10⁻⁷/° C. and less than or equal to 40×10⁻⁷/° C., or any and all sub-ranges formed from any of these endpoints.

In embodiments, the glass composition may have a density greater than or equal to 2.25 g/cm³ or even greater than or equal to 2.3 g/cm³. In embodiments, the glass composition may have a density less than or equal to 2.45 g/cm³ or even less than or equal to 2.4 g/cm³. In embodiments, the glass composition may have a density greater than or equal to 2.25 g/cm³ and less than or equal to 2.45 g/cm³, greater than or equal to 2.25 g/cm³ and less than or equal to 2.4 g/cm³, greater than or equal to 2.3 g/cm³ and less than or equal to 2.45 g/cm³, or even greater than or equal to 2.3 g/cm³ and less than or equal to 2.4 g/cm³, or any and all sub-ranges formed from any of these endpoints.

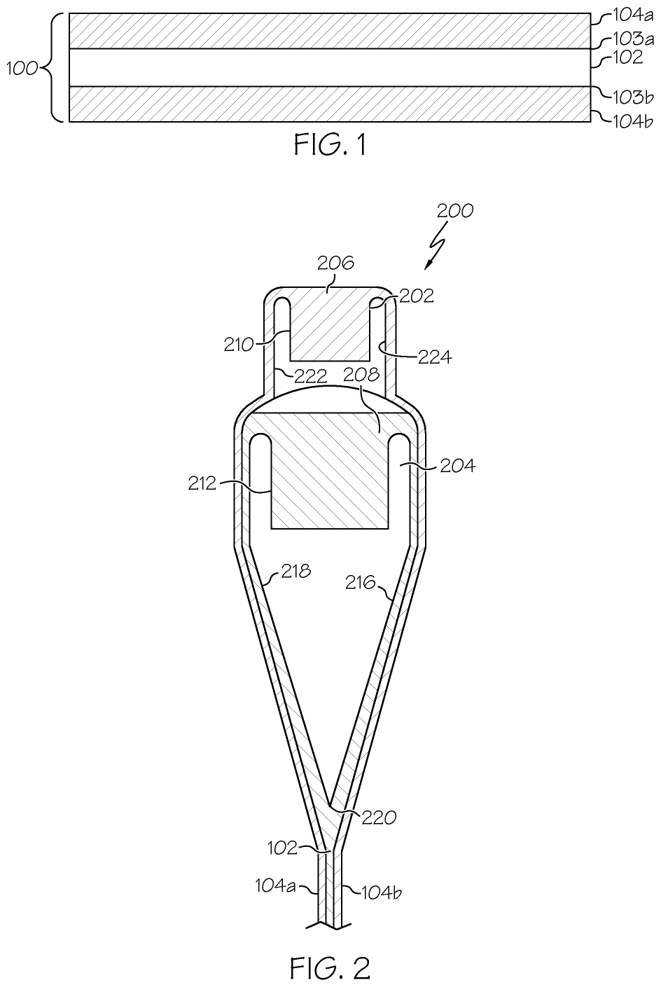

Referring now to FIG. 1, the glass compositions described herein may be used to form a glass cladding layer of a glass article, such as glass laminate article 100. The glass laminate article 100 includes a glass core layer 102 formed from a glass core composition. In embodiments, the glass core composition may be an alkaline earth boroaluminosilicate glass (e.g., Corning Eagle XG®), Corning FotoForm® Glass, Corning Iris™ Glass, or Corning Gorilla® Glass. In embodiments, the glass core composition may comprise at least one of Corning Eagle XG® Glass or Corning Iris™ Glass, for example, due to their ultra-low auto-fluorescence. One skilled in the art would understand that the glass core composition would have be to appropriately expansion and viscosity matched for the specific clad glass composition. Accordingly, in embodiments, modifications may be made to the glass core compositions to achieve viscosity matching.

The glass core layer 102 may be interposed between a pair of glass cladding layers, such as the first glass cladding layer 104a and second glass cladding layer 104b. The first glass cladding layer 104a and the second glass cladding layer 104b may be formed from a first glass cladding composition and a second glass cladding composition, respectively. In embodiments, the first glass cladding composition and/or the second glass cladding composition may comprise the glass compositions described herein. In embodiments, the first glass cladding and the second glass cladding composition may be the same composition. In embodiments, the first glass cladding composition and the second glass cladding composition may be different compositions.

FIG. 1 illustrates the glass core layer 102 having a first surface 103a and a second surface 103b opposed to the first surface 103a. The first glass cladding layer 104a is fused directly to the first surface 103a of the glass core layer 102 and the second glass cladding layer 104b is fused directly to the second surface 103b of the glass core layer 102. The glass cladding layers 104a, 104b are fused to the glass core layer 102 without any additional materials, such as adhesives, polymer layers, coating layers or the like being disposed between the glass core layer 102 and the glass cladding layers 104a, 104b. Thus, the first surface 103a of the glass core layer 102 is directly adjacentthe first glass cladding layer 104a, and the second surface 103b of the glass core layer 102 is directly adjacent the second glass cladding layer 104b. In embodiments, the glass core layer 102 and the glass cladding layers 104a, 104b are formed via a fusion lamination process. Diffusive layers (not shown) may form between the glass core layer 102 and the glass cladding layers 104a, 104b. In such case, the CTE of the diffusive layer has a value between that of the CTE of the glass core layer 102 and the glass cladding layers 104a, 104b.

In embodiments, the glass laminate article may have a thickness greater than or equal to 0.1 mm and less than or equal 3 mm, greater than or equal to 0.1 mm and less than or equal to 2 mm, greater than or equal to 0.1 mm and less than or equal to 1 mm, greater than or equal to 0.3 mm and less than or equal 3 mm, greater than or equal to 0.3 mm and less than or equal to 2 mm, greater than or equal to 0.3 mm and less than or equal to 1 mm, greater than or equal to 0.5 mm and less than or equal 3 mm, greater than or equal to 0.5 mm and less than or equal to 2 mm, or even greater than or equal to 0.5 mm and less than or equal to 1 mm, or any and all sub-ranges formed from any of these endpoints.

In embodiments, the glass laminate article 100 may have a thickness t and each glass cladding layer 104a, 104b may have a thickness greater than or equal to 0.01 t and less than or equal to 0.35 t, greater than or equal to 0.01 t and less than or equal to 0.25 t, greater than or equal to 0.01 t and less than or equal to 0.15 t, greater than or equal to 0.01 t and less than or equal to 0. It, greater than or equal to 0.025 t and less than or equal to 0.35 t, greater than or equal to 0.025 t and less than or equal to 0.25 t, greater than or equal to 0.025 t and less than or equal to 0.15 t, greater than or equal to 0.025 t and less than or equal to 0. It, greater than or equal to 0.05 t and less than or equal to 0.35 t, greater than or equal to 0.05 t and less than or equal to 0.25 t, greater than or equal to 0.05 t and less than or equal to 0.15 t, or even greater than or equal to 0.05 t and less than or equal to 0.1 t, or any and all sub-ranges formed from any of these endpoints.

The glass laminate articles 100 described herein may be formed by a fusion lamination process such as the process described in U.S. Pat. No. 4,214,886, which is incorporated herein by reference. Referring to FIG. 2 by way of example, a laminate fusion draw apparatus 200 for forming a glass laminate article includes an upper isopipe 202 which is positioned over a lower isopipe 204. The upper isopipe 202 includes a trough 210 into which a molten glass cladding composition 206 is fed from a melter (not shown). Similarly, the lower isopipe 204 includes a trough 212 into which a molten core glass composition 203 is fed from a melter (not shown).

As the molten glass core composition 208 fills the trough 212, it overflows the trough 212 and flows over the outer forming surfaces 216, 218 of the lower isopipe 204. The outer forming surfaces 216, 218 of the lower isopipe 204 converge at a root 220. Accordingly, the molten glass core composition 208 flowing over the outer forming surfaces 216, 218 rejoins at the root 220 of the lower isopipe 204, thereby forming a glass core layer 1020f a glass laminate article.

Simultaneously, the molten glass cladding composition 206 overflows the trough 210 formed in the upper isopipe 202 and flows over outer forming surfaces 222, 224 of the upper isopipe 202. The molten glass cladding composition 206 is outwardly deflected by the upper isopipe 202 such that the molten glass cladding composition 206 flows around the lower isopipe 204 and contacts the molten glass core composition 208 flowing over the outer forming surfaces 216, 218 of the lower isopipe, fusing the molten glass core composition and forming glass cladding layers 104a, 104b around the glass core layer 102.

Upon cooling of the glass laminate article 100 after the lamination process, the CTE differential between the glass core layer 102 and the glass cladding layers 104a, 104b is sufficient to cause the glass core layer 102 to contract or shrink more than the glass cladding layers 104a, 104b. This causes the glass core layer 102 to be in a state of tension and the glass cladding layers 104a, 104b to be in a state of compression. The compressive stresses in the glass cladding layers 104a, 104b inhibit fracture formation and fracture propagation into glass cladding layers 104a, 104b, thereby strengthening the glass laminate article 100.

Once the glass cladding layers 104a, 104b have been fused to the glass core layer 102 thereby forming a glass laminate article 100, the glass laminate article may be optionally shaped into a desired three-dimensional form, such as by vacuum molding or any other conventional glass shaping process.

Once the glass laminate article 100 is formed by fusing the glass cladding layers 104a, 104b to the glass core layer 102 and optionally shaped, the glass laminate article 100 is heat treated to induce phase separation in the glass cladding layers 104a, 104b thereby producing an interconnected matrix of a first phase in which at least one second phase is dispersed in the glass cladding layers 104a, 104b. The heat treatment process generally includes heating the glass laminate article to the upper consulate temperature or spinodal temperature of the phase separable glass composition from which the glass cladding layers 104a, 104b are formed and holding the glass laminate article 100 at this temperature for a time period sufficient to induce the desired amount of phase separation in the glass cladding layers 104a, 104b. In embodiments, heating the glass cladding layers 104a, 104b comprises holding the glass cladding layers at a temperature greater than or equal to 650° C. and less than or equal to 850° C. for a time period greater than or equal to 0.25 hour and less than or equal to 8 hours. In embodiments, the heating temperature to induce phase separation may be greater than or equal to 650° C. and less than or equal to 850° C., greater than or equal to 650° C. and less than or equal to 825° C., greater than or equal to 650° C. and less than or equal to 800° C., greater than or equal to 675° C. and less than or equal to 850° C., greater than or equal to 675° C. and less than or equal to 825° C., greater than or equal to 675° C. and less than or equal to 800° C., greater than or equal to 700° C. and less than or equal to 850° C., greater than or equal to 700° C. and less than or equal to 825° C., or even greater than or equal to 700° C. and less than or equal to 800° C., or any and all sub-ranges formed from any of these endpoints. In embodiments, the heating time period to induce phase separation may be greater than or equal to 0.25 hour and less than or equal to 8 hours, greater than or equal to 0.25 hour and less than or equal to 6 hours, greater than or equal to 0.25 hour and less than or equal to 4 hours, greater than or equal to 0.5 hour and less than or equal to 8 hours, greater than or equal to 0.5 hour and less than or equal to 6 hours, greater than or equal to 0.5 hour and less than or equal to 4 hours, greater than or equal to 1 hour and less than or equal to 8 hours, greater than or equal to 1 hour and less than or equal to 6 hours, greater than or equal to 1 hour and less than or equal to 4 hours, greater than or equal to 2 hours and less than or equal to 8 hours, greater than or equal to 2 hours and less than or equal to 6 hours, or even greater than or equal to 2 hours and less than or equal to 4 hours, or any and all sub-ranges formed from any of these endpoints.

In embodiments, the heat treatment time and temperature are selected such that, if the at least one second phase is subsequently removed from the first phase, the glass cladding layers 104a, 104b have a desired index of refraction due to the resulting porosity of the glass cladding layers. More specifically, the time and temperature of the heat treatment may be selected such that a desired amount and distribution of the at least one second phase is present in the interconnected matrix of the first phase which, when removed from the interconnected matrix of the first phase, produces a desired index of refraction in the glass cladding layers 104a, 104b.

In embodiments, the phase separated glass cladding layer may have an average transmittance greater than or equal to 85% and less than or equal to 99% of light over the wavelength range of 400 nm to 750 nm as measured at an article thickness of 0.7 mm. In embodiments, the phase separated glass cladding layer may an average transmittance greater than or equal to 85% or even greater than or equal to 90% of light over the wavelength range of 400 nm to 750 nm as measured at an article thickness of 0.7 mm. In embodiments, the phase separated glass cladding layer may an average transmittance less than or equal to 99%, less than or equal to 97%, or even less than or equal to 95% of light over the wavelength range of 400 nm to 750 nm as measured at an article thickness of 0.7 mm. In embodiments, the phase separated glass cladding layer may an average transmittance greater than or equal to 85% and less than or equal to 99%, greater than or equal to 85% and less than or equal to 97%, greater than or equal to 85% and less than or equal to 95%, greater than or equal to 90% and less than or equal to 99%, greater than or equal to 90% and less than or equal to 97%, or even greater than or equal to 90% and less than or equal to 95%, or any and all sub-ranges formed between any of these endpoints, of light over the wavelength range of 400 nm to 750 nm as measured at an article thickness of 0.7 mm.

In embodiments, the phase separated glass cladding layer may have a transmission haze greater than or equal to 10% and less than or equal to 120%. In embodiments, the phase separated glass cladding layer may have a transmission haze greater than or equal to 10%, greater than or equal to 15%, or even greater than or equal to 20%. In embodiments, the phase separated glass cladding layer may have a transmission haze less than or equal to 120%, less than or equal to 100%, less than or equal to 80%, less than or equal to 60%, or even less than or equal to 40%. In embodiments, the phase separated glass cladding layer may have a transmission haze greater than or equal to 10% and less than or equal to 120%, greater than or equal to 10% and less than or equal to 100%, greater than or equal to 10% and less than or equal to 80%, greater than or equal to 10% and less than or equal to 60%, greater than or equal to 10% and less than or equal to 40%, greater than or equal to 15% and less than or equal to 120%, greater than or equal to 15% and less than or equal to 100%, greater than or equal to 15% and less than or equal to 80%, greater than or equal to 15% and less than or equal to 60%, greater than or equal to 15% and less than or equal to 40%, greater than or equal to 210% and less than or equal to 120%, greater than or equal to 20% and less than or equal to 100%, greater than or equal to 20% and less than or equal to 80%, greater than or equal to 20% and less than or equal to 60%, or even greater than or equal to 20% and less than or equal to 40%, or any and all sub-ranges formed from any of these endpoints.

In embodiments, following the heat treatment to induce phase separation in the glass cladding layers 104a, 104b, the glass laminate article 100 is further processed to remove the at least one second phase from the interconnected matrix of the first phase of the glass cladding layers 104a, 104b, such as when a porous, interconnected matrix of the first phase is desired in the glass cladding layers 104a, 104b. In these embodiments, the at least one second phase may be removed from the interconnected matrix of the first phase by etching the glass laminate article. As noted herein, in embodiments, the at least one second phase has a greater dissolution rate in water, basic solutions, and/or acidic solutions than the first phase of the phase separated glass composition of the glass cladding layers 104a, 104b making the at least one second phase more susceptible to dissolution than the first phase. A variety of etchants or combinations of etchants may be used including, without limitation, hydrofluoric acid, hydrochloric acid, nitric acid, sulfuric acid, or combinations thereof. The glass laminate article 100 is contacted with the etchant for a period of time sufficient to completely remove the at least one second phase from the interconnected matrix of the first phase in the glass cladding layers 104a, 104b, thereby leaving a porous, interconnected matrix of the first phase.

As described herein, the phase separation heat treatment may be tailored to achieve the physical properties (e.g., refractive index, porosity, average pore size) necessary to achieve an anti-reflective characteristic in the AR glass laminate article.

In embodiments, the etched glass cladding layer has an effective refractive index greater than or equal to 1.15 and less than or equal to 1.3 to help reduce reflection, thereby increasing transmittance. In particular, pure silica has a higher refractive index (e.g., 1.47). The etched glass cladding layer is porous, and therefore, its “effective” refractive index is lower. In embodiments, the refractive index of the etched glass cladding layer may be greater than or equal to 1.15 or even greater than or equal to 1.2. In embodiments, the refractive index of the etched glass cladding layer may be less than or equal to 1.3 or even less than or equal to 1.25. In embodiments, the refractive index of the etched glass cladding layer may be greater than or equal to 1.15 and less than or equal to 1.3, greater than or equal to 1.15 and less than or equal to 1.25, greater than or equal to 1.2 and less than or equal to 1.3, greater than or equal to 1.2 and less than or equal to 1.25, or any and all sub-ranges formed from any of these endpoints.

In embodiments, the etched glass cladding layer may have an average pore size greater than or equal to 20 nm and less than or equal 60 nm. In embodiments, the etched glass cladding layer may have an average pore size greater than or equal to 20 nm or even greater than or equal to 30 nm. In embodiments, the etched glass cladding layer may have an average pore size less than or equal to 60 nm or even less than or equal to 50 nm. In embodiments, the etched glass cladding layer may have an average pore size greater than or equal to 20 nm and less than or equal to 60 nm, greater than or equal to 20 nm and less than or equal to 50 nm, greater than or equal to 30 nm and less than or equal to 60 nm, or even greater than or equal to 30 nm and less than or equal to 50 nm, or any and all sub-ranges formed from any of these endpoints.

In embodiments, the etched glass cladding layer may have a porosity greater than or equal to 60% and less than or equal to 80%. In embodiments, the etched glass cladding layer may have a porosity greater than or equal to 60% or even greater than or equal to 65%. In embodiments, the etched glass cladding layer may have a porosity less than or equal to 80% or even less than or equal to 75%. In embodiments, the etched glass cladding layer may have a porosity greater than or equal to 60% and less than or equal to 80%, greater than or equal to 60% and less than or equal to 75%, greater than or equal to 65% and less than or equal to 80%, or even greater than or equal to 65% and less than or equal to 75%, or any and all sub-ranges formed from any of these endpoints.

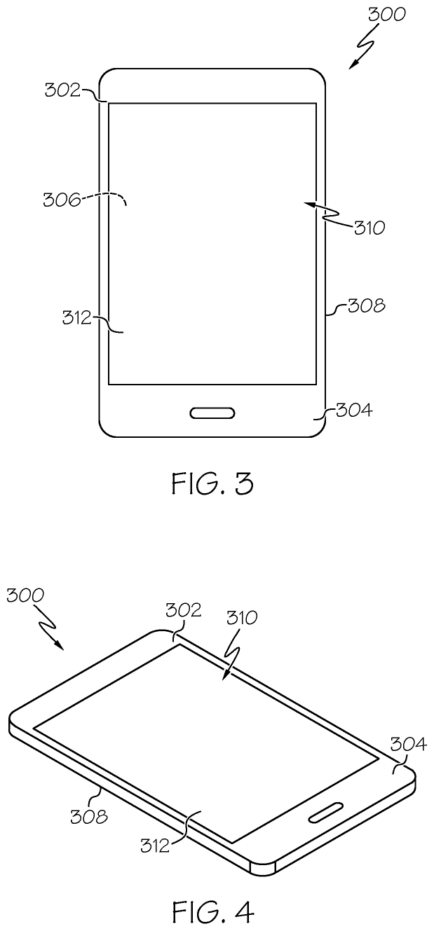

The glass laminate articles disclosed herein may be incorporated into another article such as an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article where the AR property is desired. An exemplary article incorporating any of the glass laminate articles disclosed herein is shown in FIGS. 3 and 4. Specifically, FIGS. 3 and 4 show a consumer electronic device 300 including a housing 302 having front 304, back 306, and side surfaces 308; electrical components (not shown) that are at least partially inside or entirely within the housing and including at least a controller, a memory, and a display 310 at or adjacent to the front surface of the housing; and a cover substrate 312 at or over the front surface of the housing such that itis over the display. In some embodiments, at least one of the cover substrate 312 or a portion of housing 302 may include any of the glass articles disclosed herein.

### EXAMPLES

In order that various embodiments be more readily understood, reference is made to the following examples, which are intended to illustrate various embodiments of the glass compositions described herein.

Table 1 shows a comparative glass composition and example glass compositions (in terms of mol %) and the respective properties of the glass compositions. Glasses were formed having comparative glass composition C1 and example glass compositions E1-E15.

TABLE 1

| Example | C1 | E1 | E2 | E3 | E4 | E5 |
|---|---|---|---|---|---|---|
| SiO₂ | 64.64 | 64.63 | 64.63 | 64.63 | 64.13 | 63.63 |
| Al₂O₃ | 7.38 | 7.49 | 7.49 | 7.49 | 7.99 | 8.49 |
| B₂O₃ | 16.45 | 16.30 | 16.30 | 16.30 | 16.30 | 16.30 |
| Li₂O | 0.00 | 0.30 | 0.60 | 1.20 | 1.20 | 1.20 |
| Na₂O | 0 | 0 | 0 | 0 | 0 | 0 |
| MgO | 2.20 | 2.20 | 2.20 | 2.20 | 2.20 | 2.20 |
| CaO | 8.18 | 7.88 | 7.58 | 6.98 | 6.98 | 6.98 |
| SrO | 1.12 | 1.13 | 1.13 | 1.13 | 1.13 | 1.13 |
| SnO₂ | 0.07 | 0.07 | 0.07 | 0.07 | 0.07 | 0.07 |
| R₂O | 0 | 0.30 | 0.60 | 1.20 | 1.20 | 1.20 |
| Poisson's ratio | 0.232 | 0.229 | 0.229 | 0.228 | — | — |
| Shear modulus (GPa) | 26.11 | 27.58 | 27.79 | 28.06 | — | — |
| Young's modulus (GPa) | 64.33 | 67.71 | 68.33 | 68.88 | — | — |
| Vickers hardness (VHN) | 578 | 586 | 610 | 606 | — | — |
| Strain Pt. (° C.) | 960.0 | 949.1 | 927.6 | 886.8 | 872.9 | 861.6 |
| Anneal Pt. (° C.) | 660.0 | 680.5 | 664.4 | 661.8 | 647.7 | 641.8 |
| Softening Pt. (° C.) | 615.0 | 625.8 | 609.8 | 595.0 | 601.9 | 596.4 |
| CTE (25-300° C.) | 35.0 | 36.6 | 36.1 | 37.8 | 35.6 | 35.5 |
| (×10⁻⁷/° C.) | | | | | | |
| Density ((g/cm³) | 2.350 | 2.351 | 2.351 | 2.347 | 2.349 | 2.351 |
| Liquidus | 1020 | 995 | 995 | 980 | 980 | — |
| temperature (° C.) | | | | | | |
| Liquidus | 611 | 1595 | 884 | 683 | 677 | — |
| viscosity (kP) | | | | | | |

| Example | E6 | E7 | E8 | E9 | E10 | E11 |
|---|---|---|---|---|---|---|
| SiO₂ | 63.13 | 65.15 | 65.66 | 66.15 | 64.63 | 64.63 |
| Al₂O₃ | 8.99 | 7.38 | 7.27 | 7.17 | 7.49 | 7.49 |
| B₂O₃ | 16.30 | 16.06 | 15.82 | 15.60 | 16.30 | 16.30 |
| Li₂O | 1.20 | 1.18 | 1.16 | 1.15 | 0 | 0 |
| Na₂O | 0 | 0 | 0 | 0 | 0.25 | 0.50 |
| MgO | 2.20 | 2.17 | 2.14 | 2.11 | 2.20 | 2.20 |
| CaO | 6.98 | 6.88 | 6.78 | 6.68 | 7.93 | 7.68 |
| SrO | 1.13 | 1.11 | 1.10 | 1.08 | 1.13 | 1.13 |
| SnO₂ | 0.07 | 0.07 | 0.07 | 0.07 | 0.07 | 0.07 |
| R₂O | 1.20 | 1.18 | 1.16 | 1.15 | 0.25 | 0.50 |
| Poisson's ratio | — | — | — | — | — | — |
| Shear modulus (GPa) | — | — | — | — | — | — |
| Young's modulus (GPa) | — | — | — | — | — | — |
| Vickers hardness (VHN) | — | — | — | — | — | — |
| Strain Pt. (° C.) | 858.2 | 889.2 | 893.1 | 896.3 | — | — |
| Anneal Pt. (° C.) | 641.5 | 665.4 | 658.8 | 654.6 | — | — |
| Softening Pt. (° C.) | 596.6 | 601.3 | 600.2 | 597.4 | — | — |
| CTE (25-300° C.) | 35.7 | 35.4 | 35.0 | 34.5 | — | — |
| (×10⁻⁷/° C.) | | | | | | |
| Density ((g/cm³) | 2.354 | 2.344 | 2.342 | 2.339 | — | — |
| Liquidus | 965 | 985 | — | 990 | — | — |
| temperature (° C.) | | | | | | |
| Liquidus | 1202 | 735 | — | 785 | — | — |
| viscosity (kP) | | | | | | |

| Example | E12 | E13 | E14 | E15 |
|---|---|---|---|---|
| SiO₂ | 64.63 | 64.38 | 64.13 | 65.33 |
| Al₂O₃ | 7.49 | 7.74 | 7.99 | 7.34 |
| B₂O₃ | 16.30 | 16.30 | 16.30 | 15.98 |
| Li₂O | 0 | 0 | 0 | 0 |
| Na₂O | 1.00 | 0.50 | 0.50 | 0.49 |
| MgO | 2.20 | 2.20 | 2.20 | 2.16 |
| CaO | 7.18 | 7.68 | 7.68 | 7.53 |
| SrO | 1.13 | 1.13 | 1.13 | 1.11 |
| SnO₂ | 0.07 | 0.07 | 0.07 | 0.07 |
| R₂O | 1.00 | 0.50 | 0.50 | 0.49 |
| Poisson's ratio | — | — | — | — |
| Shear modulus (GPa) | — | — | — | — |
| Young's modulus (GPa) | — | — | — | — |
| Vickers hardness (VHN) | — | — | — | — |
| Strain Pt. (° C.) | — | 903.8 | 895.2 | 914.3 |
| Anneal Pt. (° C.) | — | 659.4 | 656.1 | 667.4 |
| Softening Pt. (° C.) | — | 611.8 | 607.8 | 616.9 |
| CTE (25-300° C.) | — | 35.7 | 36.1 | 35.4 |
| (×10⁻⁷/° C.) | | | | |
| Density ((g/cm³) | — | 2.351 | 2.354 | 2.347 |
| Liquidus | — | 985 | 925 | 985 |
| temperature (° C.) | | | | |
| Liquidus | — | 1835 | 14163 | 2289 |
| viscosity (kP) | | | | |

As indicated by the example glass compositions in Table 1, glass compositions as described herein including greater than or equal to 0.1 mol % and less than or equal to 15 mol % R₂O have increased liquidus viscosity as compared to a glass composition free of R₂O (comparative glass composition C1). The presence of R₂O facilitates phase separating the glass compositions at lower temperatures.

Referring now to Table 2, glass compositions as described herein including greater than or equal to 0.1 mol % and less than or equal to 15 mol % R₂O may have a desired viscosity at relatively lower temperatures as compared to a glass composition free of R₂O. For example, example glass compositions E3-E9 had a viscosity of 35 kP at lower temperatures than comparative glass composition C1.

The addition alkalis at low concentrations may not have a linear effect on viscosity at all temperatures. This is exemplified by the minimal impact of the addition of Li₂O and Na₂O, respectively, at the temperature corresponding to a viscosity of 35 kP of example glass compositions E1, E2, and E13-E15. However, one can observe that the presence of Li₂O and Na₂O, respectively, in these glass compositions lowered the strain point and/or anneal point as compared to comparative glass composition 1, which enables phase separation at lower temperatures.

TABLE 2

| Example | C1 | E1 | E2 | E3 | E4 | E5 | E6 |
|---|---|---|---|---|---|---|---|
| Temperature | 1551 | 1605 | 1573 | 1554 | 1543 | 1531 | 1532 |
| at viscosity | | | | | | | |
| 0.2 kP (° C.) | | | | | | | |
| Temperature | 1195 | 1215 | 1191 | 1171 | 1166 | 1161 | 1169 |
| at viscosity | | | | | | | |
| 16 kP (° C.) | | | | | | | |
| Temperature | 1151 | 1169 | 1145 | 1124 | 1120 | 1116 | 1124 |
| at viscosity | | | | | | | |
| 35 kP (° C.) | | | | | | | |
| Temperature | 1098 | 1113 | 1090 | 1068 | 1065 | 1062 | 1070 |
| at viscosity | | | | | | | |
| 100 kP (° C.) | | | | | | | |
| Temperature | 1076 | 1090 | 1068 | 1045 | 1043 | 1040 | 1048 |
| at viscosity | | | | | | | |
| 160 kP (° C.) | | | | | | | |
| Temperature | 1066 | 1080 | 1057 | 1034 | 1032 | 1030 | 1038 |
| at viscosity | | | | | | | |
| 200 kP (° C.) | | | | | | | |
| Temperature | 1037 | 1049 | 1027 | 1003 | 1002 | 1000 | 1008 |
| at viscosity | | | | | | | |
| 400 kP (° C.) | | | | | | | |
| Temperature | 1021 | 1033 | 1010 | 985 | 985 | 983 | 992 |
| at viscosity | | | | | | | |
| 600 kP (° C.) | | | | | | | |
| Temperature | 1010 | 1021 | 999 | 974 | 973 | 972 | 980 |
| at viscosity | | | | | | | |
| 800 kP (° C.) | | | | | | | |
| Temperature | 1001 | 1012 | 990 | 965 | 965 | 963 | 972 |
| at viscosity | | | | | | | |
| 1000 kP (° C.) | | | | | | | |

| Example | E7 | E8 | E9 | E13 | E14 | E15 |
|---|---|---|---|---|---|---|
| Temperature | 1572 | 1579 | 1588 | 1592 | 1584 | 1611 |
| at viscosity | | | | | | |
| 0.2 kP (° C.) | | | | | | |
| Temperature | 1182 | 1186 | 1190 | 1210 | 1205 | 1221 |
| at viscosity | | | | | | |
| 16 kP (° C.) | | | | | | |
| Temperature | 1134 | 1138 | 1142 | 1164 | 1160 | 1174 |
| at viscosity | | | | | | |
| 35 kP (° C.) | | | | | | |
| Temperature | 1077 | 1081 | 1085 | 1108 | 1106 | 1118 |
| at viscosity | | | | | | |
| 100 kP (° C.) | | | | | | |
| Temperature | 1053 | 1057 | 1061 | 1086 | 1085 | 1095 |
| at viscosity | | | | | | |
| 160 kP (° C.) | | | | | | |
| Temperature | 1043 | 1047 | 1050 | 1075 | 1075 | 1085 |
| at viscosity | | | | | | |
| 200 kP (° C.) | | | | | | |
| Temperature | 1011 | 1015 | 1019 | 1045 | 1045 | 1054 |
| at viscosity | | | | | | |
| 400 kP (° C.) | | | | | | |
| Temperature | 993 | 998 | 1001 | 1028 | 1029 | 1036 |
| at viscosity | | | | | | |
| 600 kP (° C.) | | | | | | |
| Temperature | 982 | 986 | 989 | 1016 | 1018 | 1025 |
| at viscosity | | | | | | |
| 800 kP (° C.) | | | | | | |
| Temperature | 972 | 977 | 980 | 1008 | 1010 | 1016 |
| at viscosity | | | | | | |
| 1000 kP (° C.) | | | | | | |

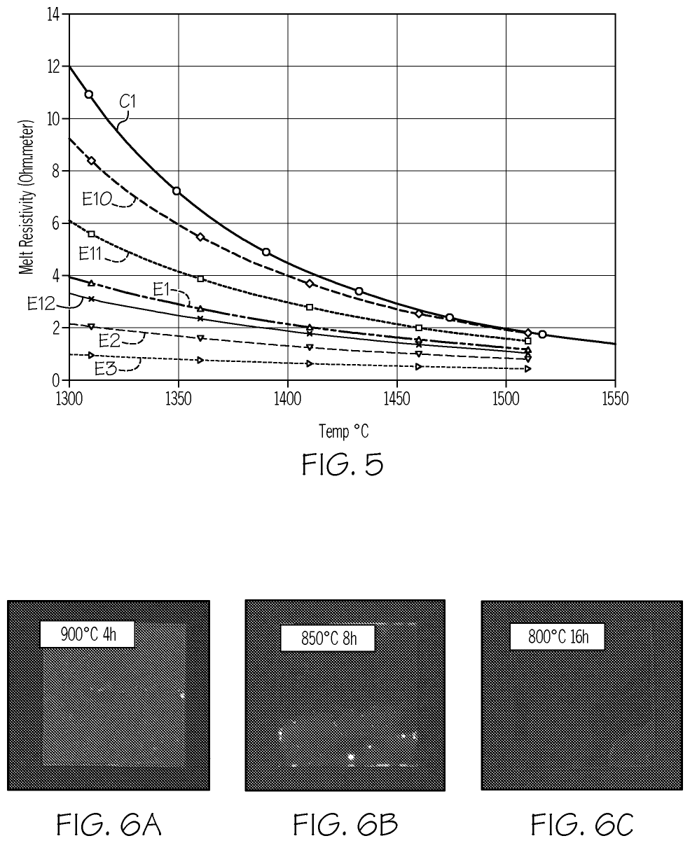

Referring now to FIG. 5, glass compositions E1-E3 and E10-E12 had lower melt resistivities than comparative glass composition C1. As indicated by FIG. 1, glass compositions as described herein including greater than or equal to 0.1 mol % and less than or equal to 15 mol % R₂O have lower melt resistivities as compared to a glass composition free of R₂O (comparative glass composition C1) such that the glass composition may be easier to melt.

Referring back to Table 1, glass compositions E1-E3 had higher Shear modulus, Young's modulus, and Vickers hardness than comparative glass composition C1. While not wishing to be bound by theory, glass compositions as described herein including greater than or equal to 0.1 mol % and less than or equal to 15 mol % R₂O may phase separate during the glass forming process, leading to improved mechanical properties as compared to a glass composition free of R₂O.

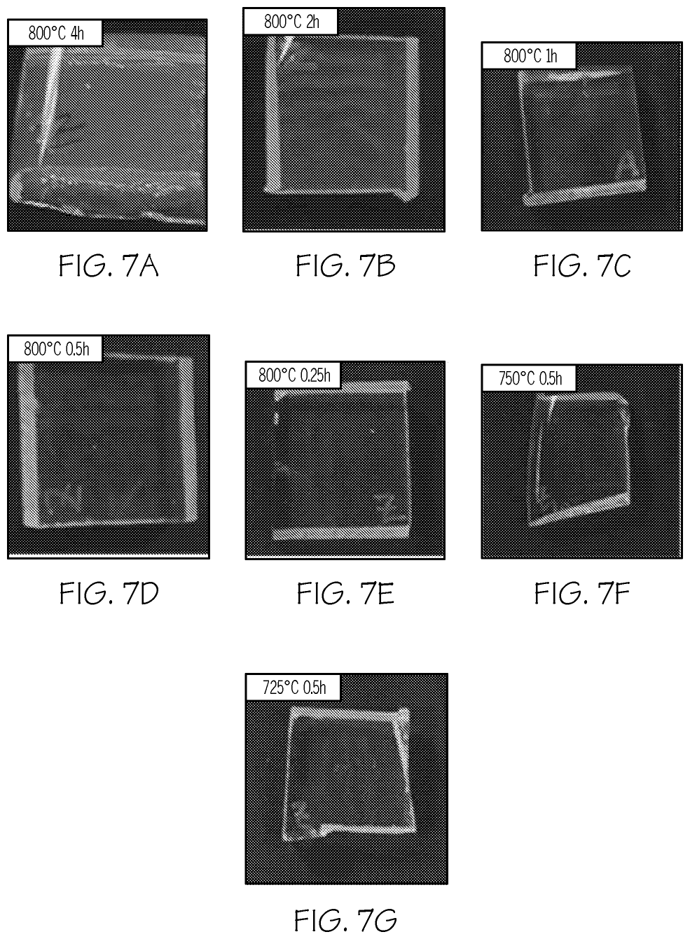

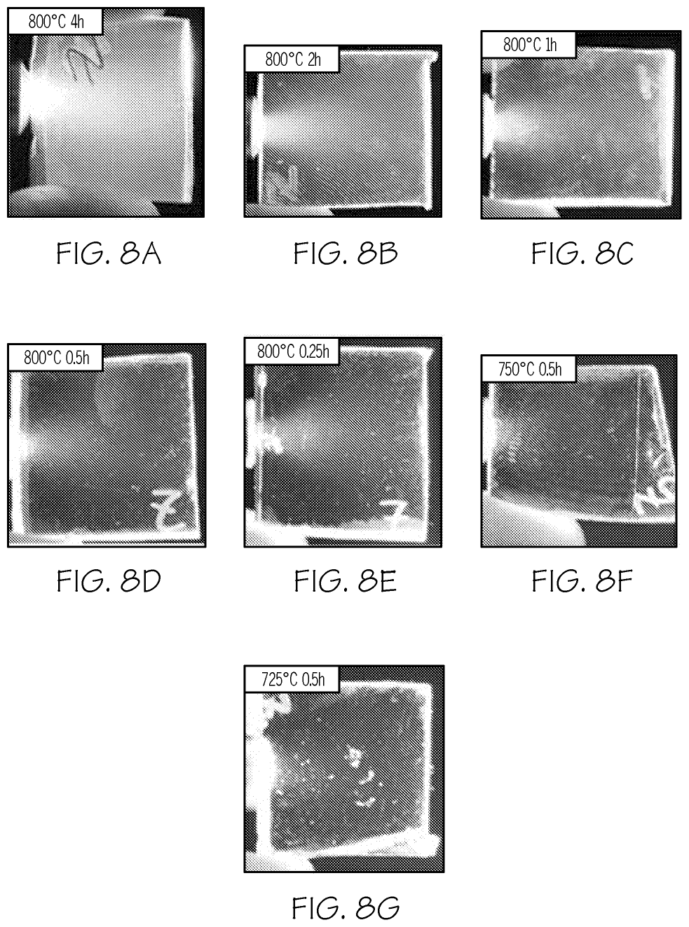

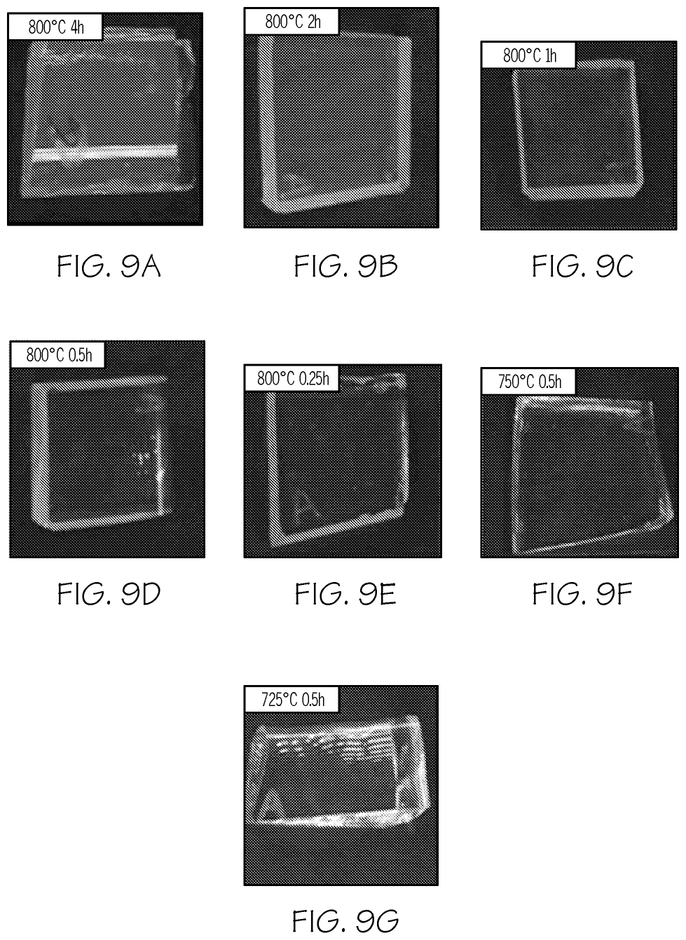

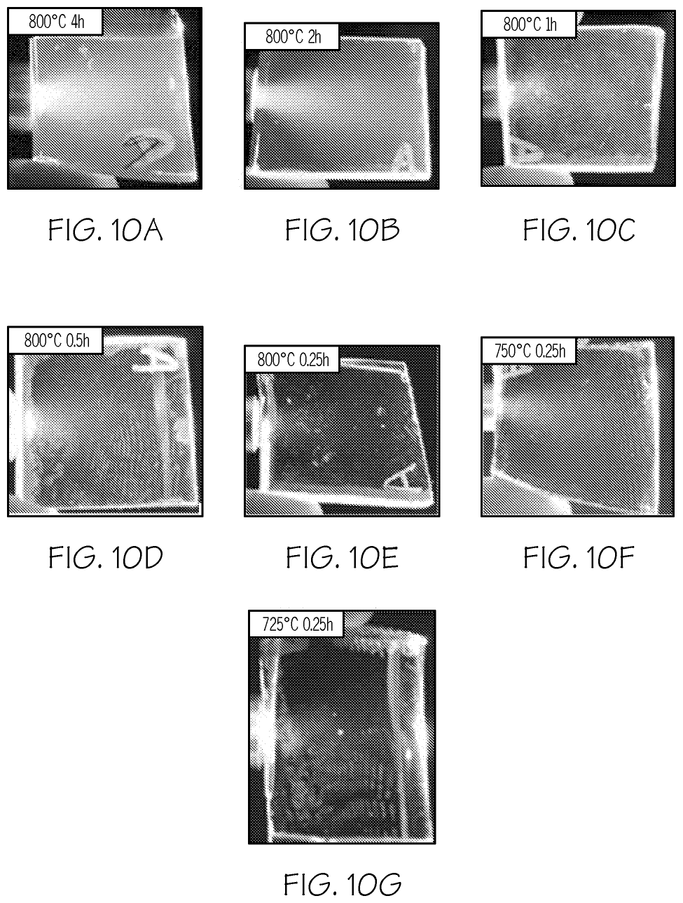

Referring now to Table 3 and FIGS. 6A-6C, 7A-7G, 8A-8G, 9A-9G, and 10A-10G, comparative glass composition C1 and example glass compositions E8 and E9 were heat treated at the time and temperatures indicated on the images to induce phase separation. FIGS. 6A-6C are images of comparative glass composition C1 after heat treatment on a black background. FIGS. 7A-7G and FIGS. 8A-8G are images of example glass composition E8 after heat treatment on a black background and under edge illumination, respectively. FIGS. 9A-9G and 10A-10G are images of example glass composition E9 after heat treatment on a black background and under edge illumination, respectively. Table 3 lists the transmission haze and the observable level of haze resulting from the specified heat treatment.

TABLE 3

| Example | C1 | E8 | E9 |
|---|---|---|---|
| 900° C. for 4 hours | — | — | — |
| | (Medium haze) | | |
| 850° C. for 8 hours | — | — | — |
| | (Low haze) | | |
| 800° C. for 16 hours | — | — | — |
| | (Low haze) | | |
| 800° C. for 4 hours | — | 111% | 74% |
| | | (High haze) | (High haze) |
| 800° C. for 2 hours | — | 51% | 23% |
| | | (High haze) | (Medium haze) |
| 800° C. for 1 hour | — | 34% | 24% |
| | | (Medium haze) | (Medium haze) |
| 800° C. for 0.5 hour | — | 43% | 106% |
| | | (Medium haze) | (High haze) |
| 800° C. for 0.25 hour | — | 19% | 21% |
| | | (Low haze) | (Medium haze) |
| 750° C. for 0.5 hour | — | 15% | 12% |
| | | (Low haze) | (Low haze) |
| 725° C. for 0.5 hour | — | 20% | 31% |
| | | (Medium haze) | (Medium haze) |

As shown by the Table 3 and the images, it took significantly higher temperatures and longer times for the glass to manifest haze due to phase separation in comparative glass composition C1 relative to example glass compositions E8 and E9. For example, FIGS. 7A and 9A, images of example glass compositions E8 and E9, respectively, after heat treatment at 800° C. for 4 hours, showed more haze (i.e., 111% and 74%, respectively (high haze)) when exposed to a heat treatment 50° C. cooler for half the time as compared to FIG. 6B, an image of comparative glass composition C1 after heat treatment at 850° C. for 8 hours (i.e., low haze). Moreover, as shown in Table 3 and FIGS. 8F, 8G, 10F, and 10G, example glass compositions E8 and E9 exhibited sufficient phase separation after heat treatment at relatively lower temperatures (e.g., 725° C.-750° C.) to scatter light. As indicated by Table 3 and FIGS. 6A-6C, 7A-7G, 8A-8G, 9A-9G, and 10A-10G, glass compositions as described herein including greater than or equal to 0.1 mol % and less than or equal to 15 mol % R₂O may be phase separated after heat treatment at lower temperatures and shorter time periods as compared to a glass composition free of R₂O.

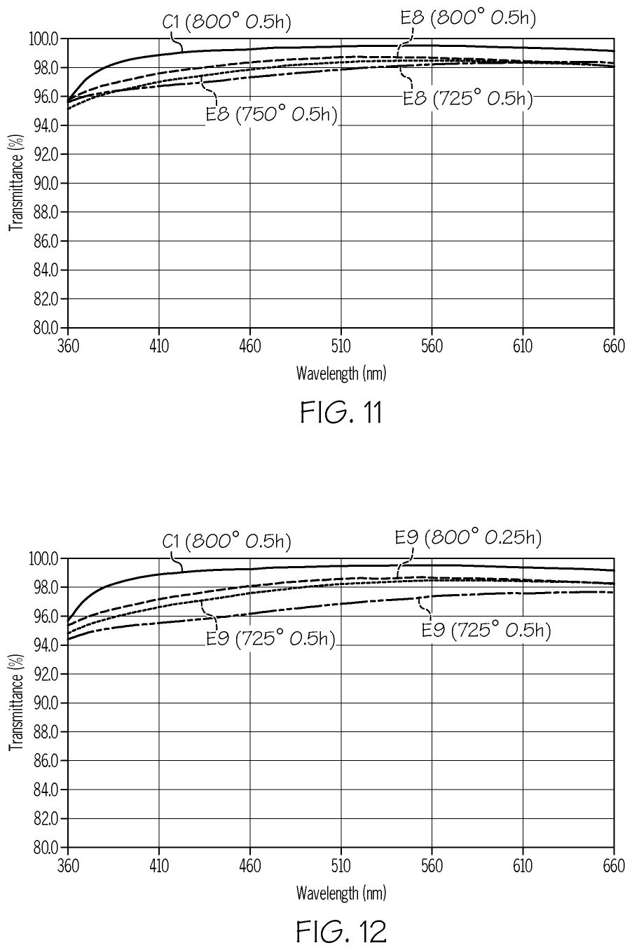

Referring now to FIGS. 11 and 12, glass compositions E8 and E9 subjected to a heat treatment results in similar transmittance as comparative glass composition C1 (i.e., glass known to be well suited for these optical properties) subjected to the same heat treatment or even heat treatment at a lower temperature. As indicated by FIGS. 11 and 12, the glass compositions described herein may be subjected to heat treatment to produce a glass laminate article having a desired transmittance.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A glass composition comprising:
greater than or equal to 50 mol % and less than or equal to 80 mol % SiO₂;
greater than or equal to 5 mol % and less than or equal to 15 mol % Al₂O₃;
greater than or equal to 10 mol % and less than or equal to 25 mol % B₂O₃;
greater than or equal to 0 mol % Li₂O;
greater than or equal to 0 mol % Na₂O;
greater than or equal to 0 mol % K₂O;
greater than or equal to 0 mol % Rb₂O;
greater than or equal to 0 mol % Cs₂O;
greater than or equal to 1.5 mol % and less than or equal to 5 mol % MgO;
greater than or equal to 4 mol % and less than or equal to 12 mol % CaO; and
greater than or equal to 0.5 mol % and less than or equal to 5 mol % SrO, wherein:
R₂O is greater than or equal to 0.1 mol % and less than or equal to 15 mol %, R₂O being the sum of Li₂O, Na₂O, K₂O, Rb₂O, and Cs₂O.

2. The glass composition of claim 1, wherein R₂O is greater than or equal to 0.25 mol % and less than or equal to 12 mol %.

3. (canceled)

4. The glass composition of claim 1, wherein the glass composition comprises greater than or equal to 13 mol % and less than or equal to 25 mol % B₂O₃.

5. (canceled)

6. The glass composition of claim 4, wherein the glass composition comprises greater than or equal to 15 mol % and less than or equal to 19 mol % B₂O₃.

7. The glass composition of claim 1, wherein the glass composition comprises greater than or equal to 6 mol % and less than or equal to 13 mol % Al₂O₃.

8. The glass composition of claim 7, wherein the glass composition comprises greater than or equal to 7 mol % and less than or equal to 11 mol % Al₂O₃.

9. The glass composition of claim 1, wherein the glass composition comprises greater than or equal to 1.75 mol % and less than or equal to 4 mol % MgO.

10. (canceled)

11. The glass composition of claim 1, wherein the glass composition comprises greater than or equal to 4.5 mol % and less than or equal to 10 mol % CaO.

12. (canceled)

13. The glass composition of claim 1, wherein the glass composition comprises greater than or equal to 0.75 mol % and less than or equal to 4 mol % SrO.

14. (canceled)

15. The glass composition of claim 1, wherein the glass composition further comprises greater than 0 mol % and less than or equal to 5 mol % BaO.

16. The glass composition of claim 15, wherein the glass composition comprises greater than 0 mol % and less than or equal to 4 mol % BaO.

17. The glass composition of claim 16, wherein the glass composition comprises greater than 0 mol % and less than or equal to 3 mol % BaO.

18. The glass composition of claim 1, wherein the glass composition further comprises greater than 0 mol % and less than or equal 0.5 mol % SnO₂.

19. The glass composition of claim 18, wherein the glass composition comprises greater than or equal to 0.01 mol % and less than or equal 0.25 mol % SnO₂.

20. (canceled)

21. (canceled)

22. The glass composition of claim 1, wherein the glass composition comprises greater than or equal to 55 mol % and less than or equal to 75 mol % SiO₂.

23. The glass composition of claim 22, wherein the glass composition comprises greater than or equal to 60 mol % and less than or equal to 70 mol % SiO₂.

24. The glass composition of claim 1, wherein the glass composition is phase separable into a first phase and at least one second phase.

25. The glass composition of claim 1, wherein the glass composition has a liquidus viscosity greater than or equal to 10 kP and less than or equal to 15000 kP.

26. The glass composition of claim 1, wherein the glass composition has a melt resistivity greater than or equal to 0.5 ohm-m and less than or equal to 15 ohm-m.

27. The glass composition of claim 1, wherein the glass composition has: (i) a shear modulus greater than or equal to 20 GPa and less than or equal to 35 GPa; or (ii) a Young's modulus greater than or equal to 60 GPa and less than or equal to 75 GPa.

28. (canceled)

29. The glass composition of claim 1, wherein the glass composition has a Vickers hardness greater than or equal to 500 VHN and less than or equal 650 VHN.

30. A glass laminate article comprising:
a core glass layer; and
a clad glass layer laminated to a surface of the core glass layer, wherein:
the core glass layer is formed from the glass composition of claim 1.

31. A method for forming a glass laminate article, the method comprising:
fusing at least one glass cladding layer to at least a portion of a glass core layer, wherein the at least one glass cladding layer comprises a phase separable glass composition and comprises:
greater than or equal to 50 mol % and less than or equal to 80 mol % SiO₂;
greater than or equal to 5 mol % and less than or equal to 15 mol % Al₂O₃;
greater than or equal to 10 mol % and less than or equal to 25 mol % B₂O₃;
greater than or equal to 0 mol % Li₂O;
greater than or equal to 0 mol % Na₂O;
greater than or equal to 0 mol % K₂O;
greater than or equal to 0 mol % Rb₂O;
greater than or equal to 0 mol % Cs₂O;
greater than or equal to 1.5 mol % and less than or equal to 5 mol % MgO;
greater than or equal to 4 mol % and less than or equal to 12 mol % CaO; and
greater than or equal to 0.5 mol % and less than or equal to 5 mol % SrO, wherein:
R₂O is greater than or equal to 0.1 mol % and less than or equal to 15 mol %, R₂O being the sum of Li₂O, Na₂O, K₂O, Rb₂O, and Cs₂O;
heating the at least one glass cladding layer fused to the glass core layer to a temperature sufficient to effect a phase separation in the at least one glass cladding layer such that, after the heating, the at least one glass cladding layer comprises a first phase and at least one second phase, each of the first phase and the at least one second phase having different compositions; and
etching the phase separated at least one glass cladding layer with an etching solution to selectively remove the at least one second glass phase from the at least one glass cladding layer such that the at least one glass cladding layer comprises a porous, interconnected matrix formed from the first phase of the phase separable glass composition.

32. The method of claim 31, wherein heating the at least one glass cladding layer comprises holding the at least one glass cladding layer at a temperature greater than or equal to 650° C. and less than or equal to 850° C. for a time period greater than or equal to 0.25 hour and less than or equal to 8 hours.

33. The method of claim 31, wherein the first phase comprises an interconnected matrix and the at least one second phase is dispersed throughout the interconnected matrix.

34. The method of claim 33, wherein the at least one second phase is interconnected within the interconnected matrix of the first phase.

35. The method of claim 31, wherein the etched at least one glass cladding layer has a refractive index greater than or equal to 1.15 and less than or equal to 1.3.

36. The method of claim 31, wherein the etched at least one glass cladding layer has an average pore size greater than or equal to 20 nm and less than or equal 60 nm.

37. The method of claim 31, wherein the etched at least one glass cladding layer has a porosity greater than or equal to 60% and less than or equal to 80%.

38. The method of claim 31, wherein the phase separated at least one glass cladding layer has an average transmittance greater than or equal to 85% and less than or equal to 99% of light over the wavelength range of 400 nm to 750 nm as measured at an article thickness of 0.7 mm.

39. The method of claim 31, wherein the at least one glass cladding layer has a haze greater than or equal to 10% and less than or equal to 120%.
